(19) United States
(12) Patent Application Publication
(10) Pub. No.: US 2015/0193904 A1
(43) Pub. Date: Jul. 9, 2015

(54) GRAPHICS ACCELERATION FOR APPLICATIONS EXECUTING ON MOBILE DEVICES WITH MULTI-OPERATING SYSTEM ENVIRONMENT

(71) Applicant: OpenMobile World Wide, Inc., Framingham, MA (US)

(72) Inventor: Jaap Vermeulen, Sterling, MA (US)

(21) Appl. No.: 14/517,000

(22) Filed: Oct. 17, 2014

Related U.S. Application Data
(63) Continuation-in-part of application No. 14/061,288, filed on Oct. 23, 2013.
(60) Provisional application No. 61/984,549, filed on Apr. 25, 2014.
(60) Provisional application No. 61/983,698, filed on Apr. 24, 2014.
(60) Provisional application No. 61/892,896, filed on Oct. 18, 2013.
(60) Provisional application No. 61/717,764, filed on Oct. 24, 2012.
(60) Provisional application No. 61/717,731, filed on Oct. 24, 2012.

(51) Int. Cl. G06T 1/20; G06F 9/44

(52) U.S. Cl. CPC G06T 1/20; G06F 9/4421; G06T 2200/28

(57) ABSTRACT

The invention provides, in some aspects, a computing device that includes a central processing unit, a graphics processing unit, and a display, all coupled (directly or indirectly for communications). The central processing unit executes a native operating system including one or more native runtime environments within which native software applications are executing, where each such native software application has instructions for execution under the native operating system. A first native software application (“ACL”) executing within one or more of the native runtime environments defines one or more hosted runtime environments within which hosted software applications are executing. Thus, for example, according to some practices of the invention, the first native software application executes code comprising those hosted runtime environment or portions thereof (such as virtual machines); whereas, in other practices, the first native software application can, instead or in addition, effect the installation, instantiation and/or invocation of services/processes that make up those environments or portions thereof (but, indeed, may not in some practices execute code comprising that environment). Each such hosted software application has instructions for execution under a hosted operating system that differs from the native operating system. Hosted software applications executing within the hosted runtime environment(s) execute instructions to effect generation of three-dimensional display graphics using a hosted graphics subsystem and a hosted windowing subsystem (collectively, “hosted graphics framework”), both common to the hosted runtime environment(s). Native software applications executing within the native runtime environment(s) likewise effect generation of three-dimensional display graphics using a native graphics subsystem and a native windowing subsystem (collectively, “native graphics framework”), also, both common to the native runtime environment(s). The three-dimensional graphics can be, for example, graphical windows (or portions thereof) representing visual sequences of games or other graphics applications. The native graphics framework is coupled to the graphics processing unit to accelerate execution of at least certain instructions in the native software applications. The hosted graphics framework and the native graphics framework cooperate to accelerate execution of at least certain instructions in the hosted software applications using the graphics processing unit.

This application claims the benefit of priority of U.S. Patent Application No. 61/984,549, filed Apr. 25, 2014, entitled Graphics Acceleration for Applications Executing on Mobile Devices with Multi-Operating System Environment. This application claims the benefit of priority of U.S. Patent Application Ser. No. 61/983,698, filed Apr. 24, 2014, entitled HOSTED APP INTEGRATION SERVICES IN MULTI-OPERATING SYSTEM MOBILE AND OTHER COMPUTING DEVICES. This application is a continuation-in-part of U.S. patent application Ser. No. 14/061,288 (now, U.S. Patent Publication No. US 2014-0115606), filed Oct. 23, 2013, entitled MULTI-PLATFORM MOBILE AND OTHER COMPUTING DEVICES AND METHODS, which claims the benefit of filing of U.S. Patent Application Ser. No. 61/892,896, filed Oct. 18, 2013, entitled MULTI-PLATFORM MOBILE AND OTHER COMPUTING DEVICES AND METHODS, U.S. Patent Application Ser. No. 61/717,764, filed Oct. 24, 2012, entitled BRIDGING NOTIFICATION SYSTEMS, and U.S. Patent Application Ser. No. 61/717,731, also filed Oct. 24, 2012, entitled SEMANTICALLY DIFFERENT TASK MANAGEMENT SYSTEM IN A SINGLE OPERATING SYSTEM. This application is also related to U.S. Patent Application Ser. No. 61/903,532, filed Nov. 13, 2013, entitled HOST-HOSTED HYBRID APPS IN MULTI-OPERATING SYSTEM MOBILE AND OTHER COMPUTING DEVICES. The teachings of all of the foregoing are incorporated herein by reference.

### BACKGROUND OF THE INVENTION

The invention pertains to digital data processing and, more particularly, to methods and apparatus for executing on a single hardware/software platform applications (“apps”) made for execution on multiple different such platforms. The invention has application in supporting cross-platform compatibility among apps for smart mobile devices, e.g., smart phones, tablet computers, set-top boxes, connected televisions, in-vehicle infotainment systems, or in-flight entertainment systems, and the like, all by way of non-limiting example.

The smart mobile device market has grown nearly 40% in the past year, according to analysts. This has been fueled, to a large degree, by the sale of devices running variants of the open-source Linux and Android operating systems. While a boon to the marketplace, those devices suffer as a result of the lack of cross-compatibility of the apps developed for them. Thus, for example, apps developed for mobile devices running the Meego operating system do not run on those executing the Tizen or Android operating systems. That problem is compounded, of course, when one turns to operating systems of entirely different lineages. For example, apps developed for Tizen do not run on those running WebOS or Windows OS, and so forth.

This is not just a problem for consumers who have purchase new mobile devices that lack compatibility with old apps. It is also a problem for manufacturers, carriers and others in the supply chain whose efforts to deliver new hardware/software platforms are stymied by the lack of a large ecosystem of available apps. App developers, too, suffer from fragmentation in the marketplace, since they may be forced to port apps to a variety of platforms in order to establish or maintain product viability.

A few prior art efforts to resolve cross-compatibility issues have met with limited success. For example, Acer's Aspire One supported dual boot modes: one for Windows OS and one for Android. However, the device could not run apps for both operating systems in a single mode.

In view of the foregoing, an object of the invention is to provide improved systems and methods for digital data processing.

Another, more particular, object is to provide such systems and methods as support executing on a single hardware/software platform applications (“apps”) made for execution on multiple different hardware/software platforms.

Still another object is to provide such systems and methods as support cross-platform compatibility among apps for smart mobile devices, e.g., smart phones, tablet computers, set-top boxes, connected televisions, in-vehicle infotainment systems, or in-flight entertainment systems and the like, all by way of non-limiting example.

These and other objects are evident in the text that follows and in the drawings.

### SUMMARY OF THE INVENTION

The foregoing are among the objects attained by the invention, which provides in some aspects a computing device that includes a central processing unit, a graphics processing unit, and a display, all coupled (directly or indirectly for communications). The central processing unit executes a native operating system including one or more native runtime environments within which native software applications are executing, where each such native software application has instructions for execution under the native operating system.

A first native software application (“ACL”) executing within one or more of the native runtime environments defines one or more hosted runtime environments within which hosted software applications are executing. Thus, for example, according to some practices of the invention, the first native software application executes code comprising those hosted runtime environment or portions thereof (such as virtual machines); whereas, in other practices, the first native software application can, instead or in addition, effect the installation, instantiation and/or invocation of services/processes that make up those environments or portions thereof (but, indeed, may not in some practices execute code comprising that environment).

Each such hosted software application has instructions for execution under a hosted operating system that differs from the native operating system.

Hosted software applications executing within the hosted runtime environment(s) execute instructions to effect generation of three-dimensional display graphics using a hosted graphics subsystem and a hosted windowing subsystem (collectively, “hosted graphics framework”), both common to the hosted runtime environment(s). Native software applications executing within the native runtime environment(s) likewise effect generation of three-dimensional display graphics using a native graphics subsystem and a native windowing subsystem (collectively, “native graphics framework”), also, both common to the native runtime environment(s). The three-dimensional graphics can be, for example, graphical windows (or portions thereof) representing visual sequences of games or other graphics applications.

The native graphics framework is coupled to the graphics processing unit to accelerate execution of at least certain instructions in the native software applications. The hosted graphics framework and the native graphics framework cooperate to accelerate execution of at least certain instructions in the hosted software applications using the graphics processing unit.

Related aspects of the invention provide a computing device, e.g., as described above, in which the native graphics framework includes (i) a native graphics interface component (“EGL”) that effects allocation of off-screen buffers, and (ii) a native compositor that generates a composite graphic from such buffers and transmits that graphic for presentation on the screen. The native graphics framework responds to instructions executed by the native software applications by populating respective ones of those off-screen buffers with graphics. The native graphics interface component creates an off-screen buffer and passes at least an identifier of that buffer to the hosted graphics framework to be populated with graphics by it in response to instructions executed by the hosted software applications.

Further related aspects of the invention provide a computing device, e.g., as described above, in which the hosted graphics framework includes a hosted compositor that generates a composite graphic from one or more off-screen buffers passed to the hosted graphics framework and assigned by the native graphics interface component to one or more hosted software applications.

Still further related aspects of the invention provide a computing device, e.g., as described above, in which the computing device includes a frame buffer that is coupled to the display and drives graphics thereto for presentation thereon. According to these aspects of the invention, the hosted graphics framework and the native graphics framework cooperate to transfer the composite graphic to at least one of the graphics processing unit and the computing device display.

In further related aspects of the invention, the native graphics interface component creates an off-screen buffer and passes at least an identifier of that buffer to the hosted graphics framework to be populated with the composite graphic by the hosted compositor.

Further related aspects of the invention provide a computing device, e.g., as described above, in which the off-screen buffer passed by the native graphics interface component to the hosted graphics framework is a pixmap.

Still further related aspects of the invention provide a computing device having features paralleling those described above in which the hosted software applications executing within the hosted runtime environment(s) execute instructions to effect generation of two-dimensional display graphics using the hosted graphics subsystem and the hosted windowing subsystem, and in which hosted graphics framework and the native graphics framework cooperate to at least one of (i) accelerate execution of at least certain graphics-related instructions in the hosted software applications using the graphics processing unit, (ii) transfer composite graphics generated by the hosted compositor to the graphics processing unit and/or the computing device display.

Other aspects of the invention provide a computing device, e.g., as described above, that executes a hybrid application in a single application address space established within a native operating system executing on the device, wherein at least one of the hosted software applications is such a “hybrid application,” i.e., it comprises (i) instructions of a conventional “hosted” software application built and intended for execution under the hosted operating system, and (ii) instructions from at least one of a runtime library and another resource of the native runtime environment.

Related aspects of the invention provide a computing device, e.g., as described above, in which the hybrid application that is executed in the single application address space additionally includes instructions from at least one of a runtime library and another resource of the hosted operating system.

Yet still further aspects of the invention provide a computing device, e.g., as described above, in which the hybrid application that is executed in the single application address space additionally includes instructions adapted from at least one of a runtime library and another resource of the hosted and/or native operating systems.

Still further aspects of the invention provide a computing device, e.g., as described above, in which the device effects creation and loading of the hybrid application for execution within the single application address space by executing instructions from at least two linker/loaders: one for the instructions of the native operating system (i.e., a native linker/loader), and one for the native instructions (a hosted linker/loader).

In related aspects, the invention provides a computing device, e.g., as described above, in which the instructions from the at least two linker/loaders are executed in the native runtime environment.

Other related aspects if the invention provide a computing device, e.g., as described above, in which the instructions of instructions comprising a software application built and intended for execution under an operating system that differs from the native operating system, i.e., a hosted operating system, and (ii) instructions from at least one of a runtime library and another resource of the native runtime environment.

Related aspects of the invention provide a computing device, e.g., as described above, in which the instructions of the hosted software application are suitable for execution on a central processing unit of the device.

Yet other aspects of the invention provide a computing device, e.g., as described above, in which creation and loading of the hybrid application is initiated upon selection for activation of a launch proxy corresponding to the hosted software application. According to some aspects of the invention, that launch proxy includes one or more of:
Instructions to link and load and execute the hosted software application using the hosted linker/loader and, then, to execute the hosted software application.
References to one or more “adapted” libraries that (i) contain at least selected classes and/or functions (collectively, “functions”) of the hosted runtime libraries and/or other resources of a hosted runtime environment called and/or potentially called by the hosted software application executable and (ii) resolve in calls to native runtime libraries.
References to one or more libraries containing other functions, if any, of the hosted runtime libraries called and/or potentially called by the hosted software application executable.
References to one or more native runtime libraries and/or native runtime environments 16 resources.
Instructions for executing the hosted linker/loader with native runtime environments to link hosted software application and to resolve references therein using (1)-(4).

Further aspects of the invention provide methods paralleling the operations for execution of the first software application on a computing device as described above.

The foregoing and other aspects of the invention are evident in the drawings and in the description that follows.

### BRIEF DESCRIPTION OF THE DRAWINGS

A more complete understanding of the invention may be attained by reference to the drawings, in which:

A more complete understanding of the invention may be attained by reference to the drawings, in which:

FIGS. 1A-1C depict a computing device of the type embodying the invention;

FIG. 2 depicts a native operating system of the type executing in the device of FIG. 1;

FIG. 3 depicts one or more hosted runtime environments defined by a native software application for execution of hosted software applications in the device of FIG. 1;

FIG. 4 depicts the interaction of components in launching an exemplary hosted software application based on user interaction with that application's launch proxy executing in a native runtime environment, displaying an application window representing operation of the hosted software application via that application's IO proxy, and transmitting user input from that proxy back to the hosted application;

FIG. 5 is a block diagram illustrating task operations in both the hosted application runtime environment and the native application runtime environment, and a one-to-one correspondence between hosted application tasks and proxy tasks, in accordance with an embodiment of the invention;

FIG. 6 is a block diagram illustrating the relationships between proxy tasks in the native application runtime environment and the complex task models and virtual frame buffer of the hosted application runtime environment, according to the task switching method of FIG. 8;

FIG. 7 is a flow chart illustrating a task switching method occurring in both the hosted application runtime environment and the native application runtime environment of the device of FIG. 5, in accordance with an embodiment of the invention;

FIG. 8 depicts interaction of the notification subsystems of the hosted runtime environments and native runtime environments in a system according to the invention

FIG. 9 depicts a notification translation function in a system according to the invention;

FIGS. 10-12 are flowcharts depicting notification translation in a system according to the invention;

FIG. 13 depicts a hybrid collection of instructions for execution a single application address space—or, more simply put, execution of a “hybrid” application 2000—according to some embodiments of the invention; and

FIG. 14 depicts a hosted application in a system according to the invention in which instructions referencing selected members of objects are replaced with references to substitute members.

### DETAILED DESCRIPTION OF THE ILLUSTRATED EMBODIMENT

Architecture

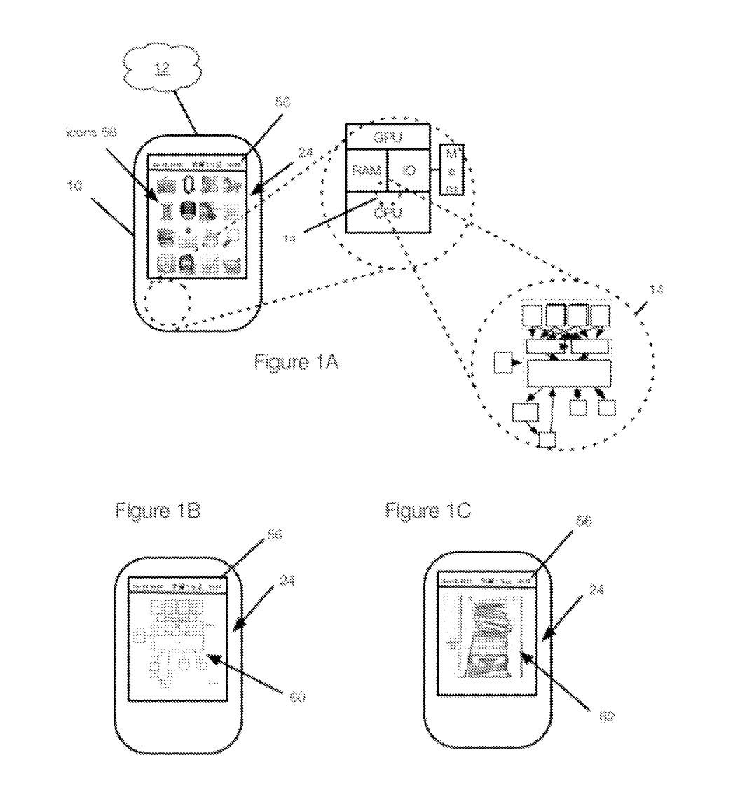

FIG. 1A depicts a computing device 10 of the type embodying the invention. The illustrated device 10 includes a central processing unit (CPU), input/output (I/O), memory (RAM) and nonvolatile storage (MEM) subsections of the type commonly provided computing devices of the type commercially available in the marketplace, all as adapted in accord with the teachings hereof. In the illustrated embodiment, the device 10 comprises a mobile computing device, such as a smart phone or tablet computer, though, in other embodiments it may comprise other computing devices, mobile or otherwise, e.g., a set-top box, connected television, in-vehicle infotainment system, or in-flight entertainment system, just to name a few.

The device 10 may be connected permanently, intermittently or otherwise to one or more other computing devices, servers, or other apparatus capable of digital communications (not shown) by a network, here, depicted by “cloud” 12, which may comprise an Internet, metropolitan area network, wide area network, local area network, satellite network, cellular network, point-to-point network and/or a combination of one or more of the foregoing, in the conventional manner known in the art, as adapted in accord with the teachings hereof.

The CPU of device 10 (e.g., in conjunction with the I/O, RAM and/or MEM subsections) executes a native operating system 14 of the type commercially available in the marketplace, as adapted in accord with the teachings hereof. Examples of such operating systems include the Meego, Tizen, Android, WebOS, and Linux operating systems, to name just a few. More generally and/or in addition, the native operating system 14 can be a Linux-based operating system, such as, by way of nonlimiting example, an Android-based operating system.

Native Runtime Environment(s)

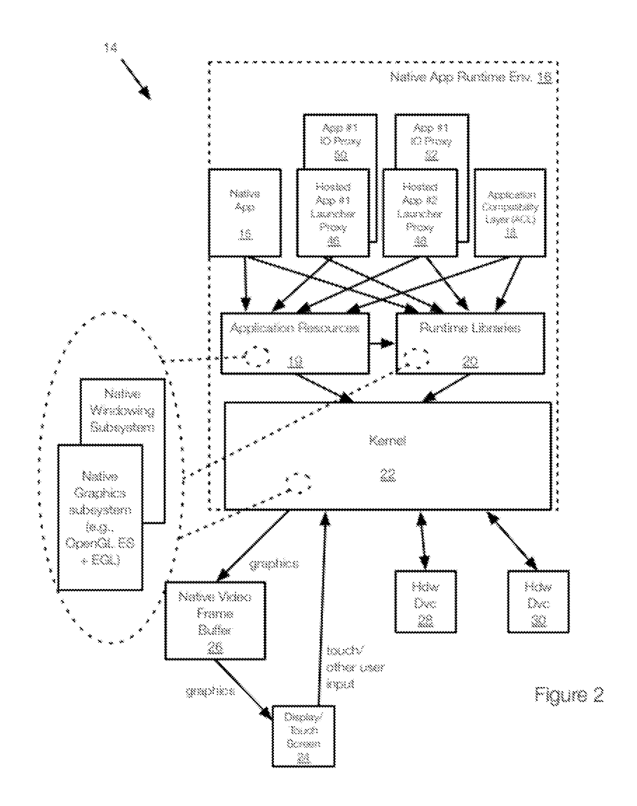

FIG. 2 depicts a native operating system 14 of the type executing on illustrated device 10 of FIG. 1.

Referring to that drawing, the native operating system 14 defines one or more native runtime environments 16 of the type known in the art (as adapted in accord with the teachings hereof) within which native software applications of the type known in the art (as adapted in accord with the teachings hereof)—i.e., applications having instructions for execution under the native operating system—are executing. Such applications are labeled 15, 18 and 46-52 in the drawing. As used here and elsewhere herein, the terms “application” and “app” are used interchangeably.

The native runtime environment(s) 16 may comprise one or more virtual machines or otherwise, as is conventional in the art (as adapted in accord with the teachings hereof), depending on the native operating system 14 and the specifics of its implementation on device 10. Illustrated native runtime environment 16 includes, by way of nonlimiting example, application resources 19 and runtime libraries 20, all of the type known in the art, as adapted in accord with the teachings hereof. That runtime environment 16 also includes a kernel 24 of the type known in the art, as adapted in accord with the teachings hereof.

Kernel 24 (or alternate functionality provided in the runtime environment(s) of alternate embodiments) serves inter alia as an interface, in the conventional manner known in the art has adapted in accord with the teachings hereof, between CPU 12 (and, more typically, the native applications executing within the native runtime environment 16 executing thereon) and hardware devices 24-30 integral or attached to device 10. This includes display/touch screen 24 and the frame buffer 26 that drive displays thereon in the conventional manner known in the art, as adapted in accord with the teachings hereof. This can also include, by way of non-limiting example, a keyboard, trackball, touch stick, other user input devices, and/or other integral or peripheral devices of the type known in the art. In the discussion that follows, the display/touch screen 24, the frame buffer 26, and other integral/peripheral devices supporting interactions between the device 10 and its user are referred to as a “hardware interface,” regardless of whether they comprise hardware, software or (as is more typically the case) a combination thereof.

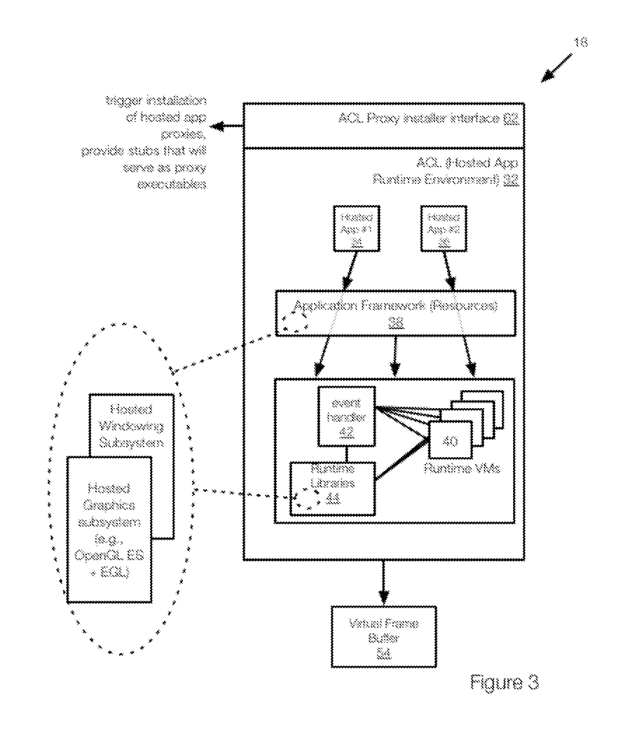

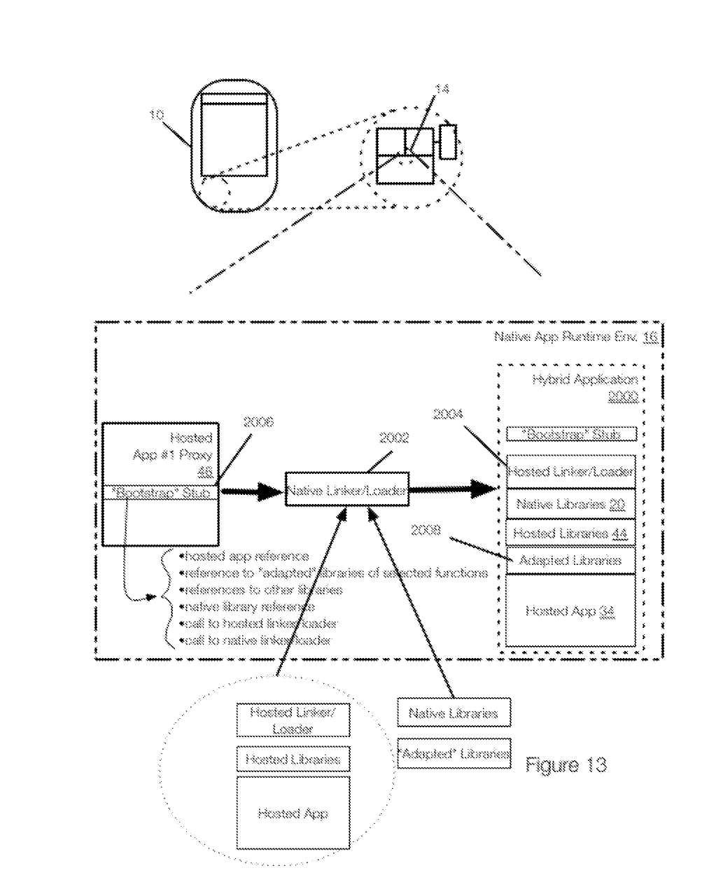

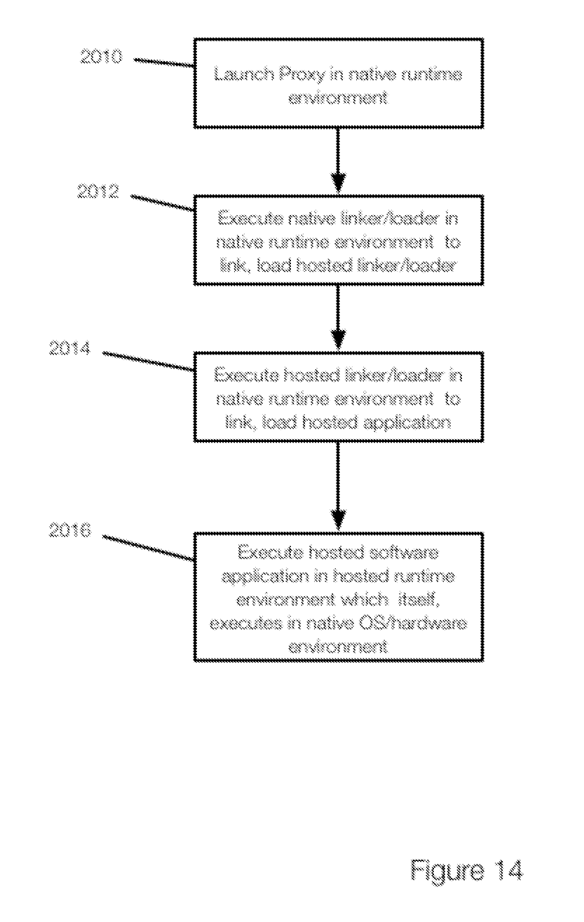

A native software application 18, referred to, here, without limitation, as the “Applications Compatibility Layer” or “ACL”, executing within the one or more native runtime environments 16 defines one or more hosted runtime environments within which hosted software applications are executing. In this regard, the application 18 can execute code comprising those hosted runtime environment(s) 32 or portions thereof (e.g., the virtual machines that make up those hosted runtime environment(s) 32). Alternatively, or in addition, the application 18 can effect the installation, instantiation and/or invocation of processes and, more typically, for example, daemons, that make up those environments 32 or portions thereof. The former approach is illustrated in FIGS. 2-3; the latter is illustrated in FIGS. 13-14 of aforementioned incorporated-by-reference application U.S. Patent Application Ser. No. 61/983,698, filed Apr. 24, 2014, entitled HOSTED APP INTEGRATION SERVICES IN MULTI-OPERATING SYSTEM MOBILE AND OTHER COMPUTING DEVICES, a copy of which is reprinted in the Appendix hereof.

Each such hosted software application has instructions for execution under a hosted operating system that differs from the native operating system.

Native software applications 46-52 are proxies of hosted software applications 34, 36. Particularly, in some embodiments, hosted software applications executing in hosted runtime environment 32 may have multiple corresponding proxies executing in the native runtime environment 16: a launch proxy and an IO proxy. Here, for illustrative purposes, hosted software application 34 is shown as having a launch proxy 46 and an IO proxy 50. Hosted software application 36 is likewise shown as having a launch proxy 48 and an IO proxy 52. Although, both launch and IO proxies are used in the illustrated embodiment, in other embodiments hosted software applications may have corresponding proxies of only one type (e.g., IO or launch) or otherwise; and, in other embodiments, one or more of the hosted software applications may have no such proxies.

Hosted Runtime Environment(s)

The hosted operating system can be, for example, a Linux-based operating system, such as, by way of nonlimiting example, an Android-based operating system. The native operating system 14 can likewise be, for example, a Linux-based and/or Android-based operating system, albeit, of a different “flavor” than that of the hosted operating system. By way of more particular example, where the native operating system 14 comprises one of the aforementioned Tizen, WebOS, Linux operating systems (as adapted in accord with the teachings hereof), by way of nonlimiting example, the hosted operating system can comprise a “flavor” of the commercially available Android operating system (as adapted in accord with the teachings hereof), again, by way of nonlimiting example.

FIG. 3 depicts one or more hosted runtime environments 32 defined by the native software application 18 (or ACL) for execution of hosted software applications 34, 36 in the device 10 according to some practices of the invention. The illustrated hosted runtime environment 32 is of the type known in the art (as adapted in accord with the teachings hereof) within which software applications having instructions for execution under the hosted operating system (i.e., hosted software applications) are built and intended to be executed.

The hosted runtime environment(s) 32 may comprise one or more virtual machines or otherwise, as is conventional in the art (as adapted in accord with the teachings hereof), depending on the type of the hosted operating system and the specifics of its implementation within the runtime environments 32. Illustrated hosted runtime environment 32 is intended for executing Android-based software applications 34, 36 (though, other embodiments may be intended for executing applications designed and built for other operating systems) and includes, by way of non-limiting example, a resource framework 38, virtual machines (VMs) 40, event handler 42 and run-time libraries 44, all by way of non-limiting example and all of the type known in the art, as adapted in accord with the teachings hereof.

The illustrated runtime environment 32 does not include a kernel per se (as might normally be included, for example, in the runtime environment of a Linux-/Android-based operating system) in the sense of running operations in a protected, kernel space of the type known in the art. Instead, some such operations (e.g., operations that might normally be included, for example, in the kernel of a Linux-/Android-based operating system) are executed in user space.

By way of example, are those kernel space operations relied upon by the resource framework 38, virtual machines (VMs) 36, event handler 42, run-time libraries 44, and/or other components of the runtime environment 32 to load graphics to a frame buffer for presentation on a display. Rather than executing in a kernel of hosted runtime environment 32, in the illustrated embodiment those operations are elevated to user space and are employed to load such graphics to a “virtual” frame buffer 54, which (as discussed below) is shared with the native runtime environment 16 and the applications executing there—particularly, the I/O proxy applications 50, 52.

The execution of other such kernel-space operations can be avoided by passing-off to native operating system 14 and its runtime environment 16 operations and, more broadly, functions required for execution of hosted software applications 34, 36 that would otherwise be performed within the runtime environment 32 and, specifically, for example by a kernel thereof.

Such passing-off, in the illustrated embodiment, is effected, for example, by the resource framework 38, virtual machines (VMs) 36, event handler 42, run-time libraries 44, and/or other components of the runtime environment 32, which communicate with and/or otherwise rely on the native software application proxies 46-52 (executing in runtime environment 16) of hosted software applications 34, 36 to perform such functions or alternates thereof.

A further appreciation of the foregoing may be attained through the discussion that follows and elsewhere herein, as well as within the incorporated-by-reference applications identified below.

Native and Hosted Software Application Installation

Native software applications, e.g., 15 and 18, are installed (upon direction of the user or otherwise) on device 10 and, more particularly, for execution within native runtime environments 16, in the conventional manner of the art for installations of apps within operating systems of the type of operating system 14. Such installation typically involves cooperative action of native operating system 14 and the runtime environments 16 executing an “installer” app (not shown) of the type conventional to OS 14 and typically includes unpacking, from an application package file (e.g., downloaded from a developer site or otherwise), the to-be-installed application's executable file, icon file, other support files, etc., and storing those to designated locations in static storage (MEM) on device 10, again, in the conventional manner known in the art, as adapted in accord with the teachings hereof. Such application package files are referred to herein as “native” application package files.

Hosted software applications 34, 36 are installed (upon direction of the user or otherwise) under control of ACL 18 for execution under hosted runtime environments 32. To that end, the ACL 18 can utilize an installer app the type conventional to the hosted operating system, albeit, modified as discussed herein, e.g., to unpack from the application package files, or otherwise, the to-be-installed application's executable file, icon file, other support files, etc., to suitable locations in static storage (MEM) on device 10, e.g., locations dictated by native operating system 14, yet, consistent with the hosted operating system, or otherwise. Such application package files are referred to herein as “hosted” application package files.

Unlike other native software applications, e.g., 15 and 18, the native software applications 46-52, if any, that are proxies of a hosted software application 34, 36 are installed, by request from ACL 18 to native operating system 14, in connection with the installation by ACL 18 of each respective hosted software application. Each such proxy 46-52 is installed by the native operating system 14 in the conventional manner, albeit, from application package files (or otherwise) generated by ACL's 18 proxy installer interface 62, which triggers installation of those proxies.

Those package files can include, in lieu of the respective hosted software application 34, 36 executable, a “stub” executable suitable for
(ii) execution under native operating system 14 and, particularly, within native runtime environments 16,
(ii) effecting the functions discussed below (and elsewhere herein) attributable to the launch proxies and the IO proxies, respectively.

Those package files can also include icon files that are identical to or variants of those originally supplied with the application package files (or otherwise) for the respective hosted software applications 34, 36. Although, in the illustrated embodiment, two proxies may be associated with each hosted software application, only a single icon is associated with both proxies as displayed on the graphical desktop, e.g., of FIG. 1A.

Hosted Execution Environment Integration

As illustrated in FIGS. 2-3, in some embodiments, the native application 18 executes the code that makes up the hosted runtime environment(s) 32, e.g., the code comprising the substituent resource frameworks 38, virtual machines 40, event handlers 42, run-time libraries 44, and/or other components of the environments 32. In this regard, application 18 can be likened to an emulator; although that analogy can be said to break down, for example, when the roles of the native applications that serve as proxies 50, 52 are taken into account as discussed herein.

The analogy can also be said to break down in embodiments where the instruction set utilized by the hosted application 34 is suitable for execution on the CPU of device 10 (or, put another way, where the native and hosted operating systems are both targeted to the same CPU, i.e., that provided by device 10). In such embodiments, execution of the hosted software application 34 instructions can be carried out directly by the CPU of device (and not, for example, merely emulated by native software application 18)—though, the handling of interrupts generated by and/or calls made in the course of such execution may be handled by the hosted runtime environments 32 (whether, themselves, executed by application 18 or otherwise).

Conversely, in other embodiments, application 18 can, instead, effect the installation, instantiation and/or invocation of processes—and, more typically, for example, daemons—providing services that make up those environments 32 without itself executing the code that makes them up. This is illustrated in FIGS. 13-14 of aforementioned incorporated-by-reference application U.S. Patent Application Ser. No. 61/983,698, filed Apr. 24, 2014, entitled “HOSTED APP INTEGRATION SERVICES IN MULTI-OPERATING SYSTEM MOBILE AND OTHER COMPUTING DEVICES,” which parallel FIGS. 2-3 hereof and which use like reference numbers to identify like elements, showing daemons (or other background processes) 33 which provide those services.

In some such embodiments, when native software application 18 is installed on device 10 under native operating system 14, the application 18 itself, its installation package, or other functionality (e.g., the native operating system 14) concurrently installs, instantiates and invokes daemons 33 on device 10, e.g., for execution as persistent background processes that auto-load with each reboot of device 10 and/or operating system 14. In related embodiments, native software application 18 effects installation, instantiation and invocation of such persistent/auto-loading daemons 33 when the application 18 is executed for a first time by the user of device 10. In yet other embodiments, application 18 installs, instantiates and/or invokes the daemons 33 on a one-time or short-term basis, persisting those daemons for only so long as application 18 is itself executing on device 10. Still other embodiments utilize other mechanisms for installing, instantiating and/or invoking daemons 33, e.g., under control of application 18 or otherwise.

Of course, it will be appreciated that, although, multiple daemons 33 are shown in the drawing, in some embodiments other numbers of daemons (for example, just one) may be utilized. And, although, the daemons may be allocated on a per service basis in the illustrated embodiment, in other embodiments they may be allocated on a per hosted application-basis, a per proxy basis, or otherwise.

In yet other embodiments, application 18 takes a mix of the approaches discussed above, e.g., executing code that makes up some portions of the environments 32 (e.g., like shown in FIGS. 2-3, while installing, instantiating and/or invoking services/process to provide services making up other portions of those environments (e.g., like shown in FIGS. 13-14 of aforementioned incorporated-by-reference application U.S. Patent Application Ser. No. 61/983,698, filed Apr. 24, 2014, entitled “HOSTED APP INTEGRATION SERVICES IN MULTI-OPERATING SYSTEM MOBILE AND OTHER COMPUTING DEVICES”).

Multi-Operating System Mobile and Other Computing Devices

The computing device 10 supports the seamless execution of applications of multiple operating systems—or, put another way, it merges the user experience so that applications executed in the hosted runtime environment appear, to the user, as if they are executing within the native operating system 14.

Thus, for example, application windows representing execution of the hosted software applications are presented to the user without interfering with the status bar that forms part of the “desktop” generated as part of the overall graphical user interface by the native operating system 14 and/or native runtime environment 16, thus, making the hosted software applications appear similar to native software applications. This is shown, by way of example, in FIGS. 1A-1C.

Referring to FIG. 1A, the native operating system 14 drives the computing device to display, on display/touch screen 24, a graphical desktop with icons 58 representing applications that can be selected for launch or other activation by the user of the device 10. In the illustrated embodiment, these can be native software applications, e.g., 15, and hosted software applications, e.g., 34, 36.

That desktop display includes a status bar 56 of the type conventional in the art—and, particularly, conventional to native operating system 14 (although, some embodiments may vary in this regard). Here, that status bar 56 indicates the current date/time, carrier conductivity signal strength (e.g., Wi-Fi, cellular, etc.), active apps, and so forth, though, in other embodiments, it may indicate other things.

Referring to FIG. 1B, when a native software application, e.g. 15, is activated by the operating system 14 and/or runtime environments 16 in response to user selection, the application window 60 generated for it by the native runtime environment 16 (reflecting execution of the application) for presentation on the screen 24 occupies that screen along with the status bar 56—here, particularly, with the status bar 56 on the top fraction of the screen and the application window 60 on the remainder. Put another way, the operating system 14 and/or runtime environments 16 do not overwrite the status bar 56 with the applications window 60. (Of course, it will be appreciated that this is the default mode of operation of the operating system 14 and/or runtime environments 16, and that in other modes, e.g., so called “full screen” modes, the application window 60 may occupy the entirety of the screen).

Referring to FIG. 1C, likewise, in the illustrated embodiment, when a hosted software application 34, 36 is activated, the application window generated for it (reflecting execution in the hosted runtime environments 32) is presented identically on the screen 24 as that of a native software application—that is, it is presented without overwriting the status bar 56 (e.g., at least when displaying in default mode).

Another example of the illustrated computing device's 10 merging the user experience so that applications executed in the hosted runtime environment appear, to the user, as if they are executing within the native operating system 14 is the use of a common notification mechanism, e.g., that of the native operating system 14 and/or runtime environments 16, as discussed in the incorporated-by-reference applications identified below.

Still another example is the consistent activation of running software applications in response to user replies to notifications (and otherwise), whether they are native applications, e.g., 15, or hosted software applications 34, 36, Again, as identified by the incorporated-by-reference applications identified below.

Yet still another example is the use of consistent theming as between the hosted software applications and native software applications, as discussed above.

Still other examples will be evident to those skilled in the art from the discussion that follows and otherwise.

Hosted Application Display in Multi-Operating System Mobile and Other Computing Devices

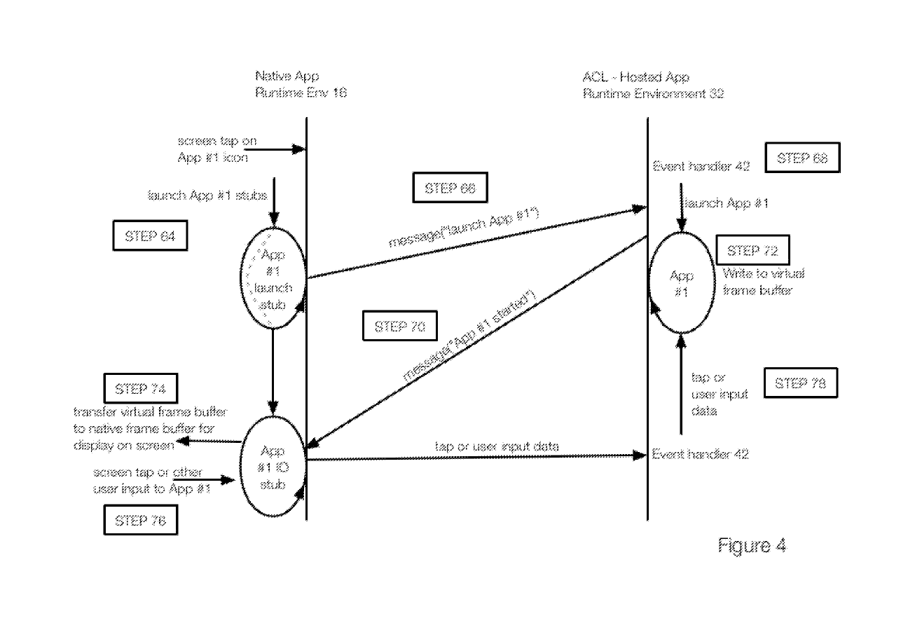

A further understanding of the operation of device 10 in these regards may be appreciated by reference to FIG. 4, which depicts the interaction of the components discussed above in launching an exemplary hosted software application 34 (here, labelled “App 1”) in hosted runtime environments 32 based on user interaction with that app's launch proxy 46 (here, labelled “App #1 Launch Stub”) executing in native runtime environments 16, displaying an application window representing operation of hosted software application 34 via that app's IO proxy 50 (here, labelled “App #1 IO Stub”), and transmitting user input from that proxy 50 back to the app 34.

Prior to illustrated step 64, native runtime environments 16 (and/or native operating system 14) present on the above-described graphical desktop (see, e.g., FIG. 1A) icons 58 representing native and hosted software applications that can be selected for launch or other activation by the user of the device 10. As noted above, those icons are provided to native runtime environments 16 and/or native operating system 14 in connection with installation of the respective apps.

As per convention of operating systems of the type of native operating system 14, the native software application that is launch proxy 46 is launched by native runtime environments 16 and/or native operating system 14 upon its selection for activation by the user. See, step 64. Proxy 50 can be simultaneously launched by native runtime environments 16 and/or native operating system 14; alternatively, proxy 50 can be launched by proxy 46 upon its launch. Id.

Upon launch (or other notification of activation from native runtime environments 16 and/or native operating system 14), proxy 46 effects activation of corresponding hosted software application 34. See, step 66.

In the illustrated embodiment, proxy 46 does this by transmitting a launch message to the event handler 42 that forms part of the hosted runtime environments 32 and that is common to the one or more hosted software applications 34, 36 (e.g., in that it is the common, shared recipient of system level-events, such as user input to the hardware interface, which events it distributes to appropriate hosted applications or other software executing in the hosted runtime environments 32 or provided as part of the hosted operating system). The launch message, which can be delivered to event handler 42 by proxy 46 using any convention mechanism for inter process communication (IPC), e.g., APIs, mailboxes, etc., includes an identifier of the proxy 46 and/or its corresponding hosted software application 34, as well as any other information required by the hosted operating system and/or hosted runtime environments 32 to effect launch of a hosted software application.

In step 68, the event handler 42 launches the hosted software application 34 in the conventional manner required of hosted operating system and/or the hosted runtime environments 32. Put more simply, that app 34 is launched as if it had been selected by the user of device 10 directly.

Following launch of hosted software application 34, event handler 42 uses IPC, e.g., as described above, to signal that hosted software application 34 has begun execution and, more aptly, to insure launch (if not already effected) and activation of proxy application 50 with the native runtime environments 16. See, step 70.

Following launch, hosted software application 34 runs in the conventional manner within hosted runtime environments 32—e.g., generating interrupts and making such calls to the hosted resource framework 38, hosted event handler 42 and run-time libraries 44, all by way of non-limiting example—as it would otherwise make if it were installed on a device executing a single operating system of the type of the hosted operating system. This is advantageous in that it does not require special recoding (i.e., “porting”) of the hosted software application 34 by the developer or publisher thereof in order to make it possible to run in the multi-operating system environment of device 10.

Hosted resource framework 38, hosted event handler 42, run-time libraries 44, and the other components of hosted runtime environments 32 respond to such interrupts and calls in the conventional manner known in the art of operating systems of the type of hosted operating system, all as adapted in accord with the teachings hereof. Thus, for example, as noted above, some such operations (e.g., those for loading frame buffers) of the type that might normally be executed in a privileged kernel space by hosted runtime environments 32 are, instead, executed in user space. And, by way of further example, other such operations (or, more broadly, functions) are passed-off to native operating system 14 and its runtime environment 16, e.g., via the proxies 46-52.

By way of example, in lieu of loading an actual frame buffer with graphics defining an applications window representing execution of the hosted software application 34, the hosted runtime environment 32 loads the virtual frame buffer 54 with such graphics. See, step 72. The hosted runtime environment 32 effects this through use of windowing and graphics subsystems that form part of the hosted runtime environment 32 and that is common to the one or more hosted software applications 34, 36 (e.g., in that it is the common, shared system used by the hosted software applications for generating applications windows for display to the user of device 10.)

The IO proxy 50 of hosted software application 34 effects presentation on screen 24 of the applications windows generated for application 34 by hosted runtime environments 32, e.g., in the manner shown in FIG. 1C and discussed in connection therewith above. See, step 74. IO proxy 50 does this by transferring the graphics defining that applications window from virtual frame buffer 54 to the native frame buffer 26, e.g., using an API provided by native runtime environments 16 for such purpose or otherwise. Although in some embodiments, the hosted runtime environments 32 utilizes messaging to alert IO proxy 50 of the need for effecting such a transfer, e.g., when the window subsystem of hosted runtime environments 32 has generated an updated applications window for hosted software application 34, when hosted software application 34 becomes the active (or foreground) app in hosted runtime environments 32, or otherwise, in other embodiments IO proxy 50 effects such transfers on its own accord on a periodic basis or otherwise.

User/Hosted Application Interaction in Multi-Operating System Mobile and Other Computing Devices

IO proxy 50 utilizes a mechanism paralleling that discussed above in connection with steps 64-68 in order to transmit taps and other input made by the user to device 10 and specifically, for example, to display/touch screen 24, a keyboard, trackball, touch stick, other user input devices. In this regard, a common event handler (not shown) or other functionality of native runtime environments 16 notifies applications executing within them, including the IO proxies 50, 52, of user input made with respect to them via the touch screen 24 or those other input devices. Such notifications are made in the conventional manner known in the art of operating systems of the type of native operating system 14, as adapted in accord with the teachings hereof.

When IO proxy 50 receives such a notification, it transmits information with respect thereto to its corresponding hosted software application 34 via event handler 42, e.g., in a manner similar to that discussed above in connection with step 66. See, step 76. That information, which can be delivered to event handler 42 by IO proxy 50 using any conventional IPC mechanism, can include an identifier of the IO proxy 50 and/or its corresponding hosted software application 34, an identifier of the device to which input was made, the type of input, and relevant information with respect thereto (e.g., location, time, duration and type of touch, key tapped, pressure on pointer, etc.). That information is received by event handler 42 and applied to the corresponding hosted software application 34 in the conventional manner required of hosted operating system and/or the hosted runtime environments 32, e.g., as if the touch or other user input had been made directly to hosted software application 34. See, step 78.

Hosted Application Utilization of Native Operating System Proxies in Multi-Operating System Mobile and Other Computing Devices

As discussed above and elsewhere herein, the respective hosted software applications (e.g., 34) utilize their corresponding proxies (e.g., 46) to perform the following, by way of nonlimiting example:
present (via operation of native operating system 14) icons on the native operating system 14 graphical desktop of display/touch screen 24 for selection by the user;
present on display/screen 24 applications windows generated by the respective hosted software applications;
to relay to the hosted runtime environments 32 launch and activation requests, e.g., signaled by the user via the display/touch screen 24 and native operating system 14;
to relay to the hosted runtime environments 32 taps and other input made by the user to device 10 and specifically, for example, to display/touch screen 24, a keyboard, trackball, touch stick, other user input devices;
to effect bringing the hosted software applications to the virtual foreground in the hosted runtime environments 32.

The hosted software applications can similarly use proxies executing in the native runtime environments 16—e.g., proxies 46-52 or otherwise—for access to other resources of the native operating system 14 and native runtime environments 16, as well as of the hardware resources of the device 10

Thus, for example, hosted software applications, e.g., 34, that utilize a still, video or other camera provided with device 10 (e.g., natively or otherwise) can access and/or alter pictures, movies of other image(s) and/or related data generated by that camera and/or by associated application resources 19 and/or runtime libraries 20 (and, more generally, by native runtime environments 16) through use of the IO proxy 50 or another proxy, e.g., associated with that same hosted software application.

To this end, paralleling the actions discussed in connection with Step 72, when a camera subsystem that forms part of the hosted runtime environment 32 (e.g., and that is common to the one or more hosted software applications) is invoked by a hosted software application, that subsystem loads a buffer and/or messages the natively-executing proxy corresponding to that hosted software application in order to identify primitives to be executed within the native runtime environments 16. Paralleling the actions discussed in Step 74, the proxy can utilize a camera subsystem of the native runtime environments 16 (or other functionality) to execute those primitives. The proxy can, them, reload that or another buffer or otherwise generate a message with results of such execution and can pass that back to the hosted runtime environments 32 via its event handler 42, e.g., paralleling the actions discussed above in connection with Step 76. The camera subsystem of the hosted runtime environments 32 responds to notification from that event handler 42 by returning to the requisite image(s) and/or other information to the hosted software application that invoked that subsystem.

By way of further nonlimiting example it will be appreciated that natively-executing proxies can be utilized by hosted software applications to accesses a telephony-related services and/or related data provided by device 10 and/or its native runtime environments 16. This includes not only use of the so-called telephone function (i.e., to make and receive calls), but also telephone logs, address books and other contact information.

Coordination of Foreground Application Tasks in Multi-Operating System Mobile and Other Computing Devices

Native runtime environments 16 responds to activation of an executing native application, e.g., via user selection of the corresponding applications window or icon on the desktop of display 24, or otherwise, by bringing that applications window to the foreground and making it the active task with which the user interacts (and to which user input is directed). Similar functionality is provided by the event handler 42 of hosted runtime environments 32, albeit with respect to executing hosted software applications, with respect to a virtual desktop residing on virtual frame buffer 54, and with respect to virtual user input devices.

In order to more fully merge the user experience so that applications executed in the hosted runtime environments 32 appear, to the user, as if they are executing within the native operating system 14, when IO proxy 50 is brought to the foreground of the graphical user interface presented on the aforementioned desktop by the windowing subsystem of native runtime environments 16 (e.g., as a result of a user tap on the application window for IO proxy 50, as a result of issuance of a notification with respect to that application or otherwise), that IO proxy 50 effects making the corresponding hosted software application 34 active within the one or more hosted runtime environments 32, as if it had been brought to the foreground in them.

An understanding of how this is effected in the illustrated embodiment may be attained by reference to the discussion that follows, in which:
the term “task” is used in place of the term “application”;
the term “interactive task” is used in reference to an application for which an applications window is generated as part of the graphical user interface of the respective operating system and/or runtime environment reflecting execution that application;
the term “foreground task” is used in reference to an application with which the user of device 10 is currently interacting;
the term “simple interactive task” refers to an application running in one process;
the term “complex interactive task” refers to an application running in more than one process; and
although a differing elemental numbering scheme is used, like names are used for like components discussed above and shown in FIGS. 1-4.

The teachings below provide for managing tasks (i.e., applications) where the designation of a foreground task in the hosted application runtime environment 32 is independent of the designation of a foreground task in the native application runtime environment 16, and where tasks in the hosted application runtime environment 32 may (or may not) span multiple processes.

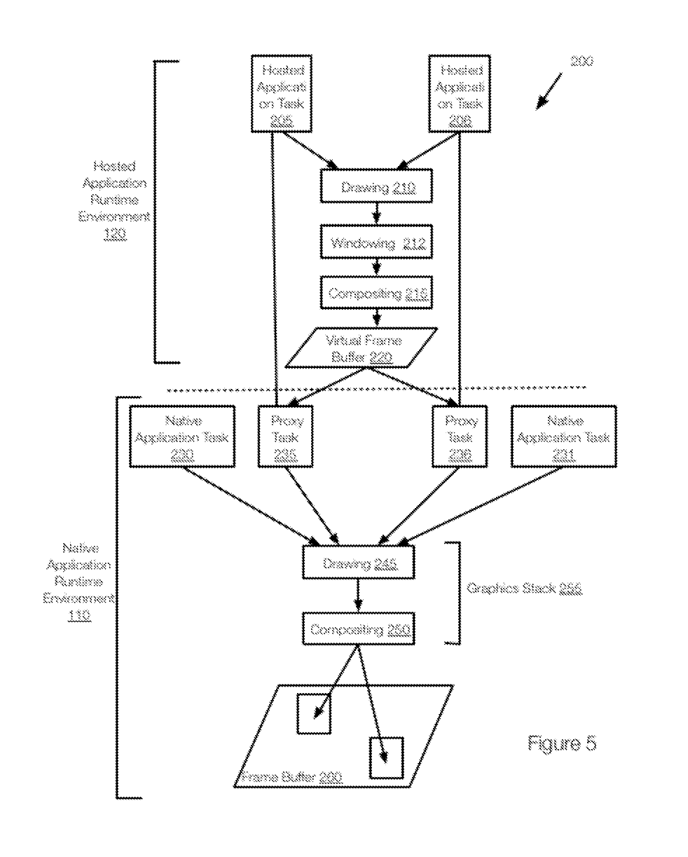

With reference to FIG. 5, in accordance with the illustrated embodiment of the invention, native application tasks in operating systems with simple task models (such as native operating system 105) are each associated with a single process. Interactive native application tasks 230, 231 are further differentiated from non-interactive tasks (not shown) by their utilization of the graphics stack 255 of the native application runtime environment 110. The graphics stack 255, comprised of drawing module 245 and compositing module 250, updates the contents of the native frame buffer 260 with the visual portions of the foreground task for display to a user via display/touch screen 24.

Hosted (or non-native) application tasks 205, 206 reside within the hosted application runtime environment 120. If the hosted application runtime environment 120 employs a different task model than the native operating system 105, each hosted application task 205, 206 is associated with a proxy (or client) task 235, 236, respectively. The proxy tasks 235, 236 reside within the native application runtime environment 110 along with the native application tasks 230, 231, and are managed by the same native task management system in the native application runtime environment 110 as the native application tasks 230, 231.

The proxy tasks 235, 236 monitor the state (foreground or background) of the hosted application tasks 205, 206, and enable the hosted application tasks 205, 206 to be fully functional within the device 100, despite the differences between the application runtime environments 110 and 120. In the illustrated embodiment, proxy tasks are created when the hosted tasks are created, but this is not a limitation of the invention.

Hosted application runtime environment 120 comprises a drawing module 210, a windowing module 212, and a compositing module 215, that together provide the visual portions of the hosted application tasks 230, 231 to the virtual frame (or screen) buffer 220.

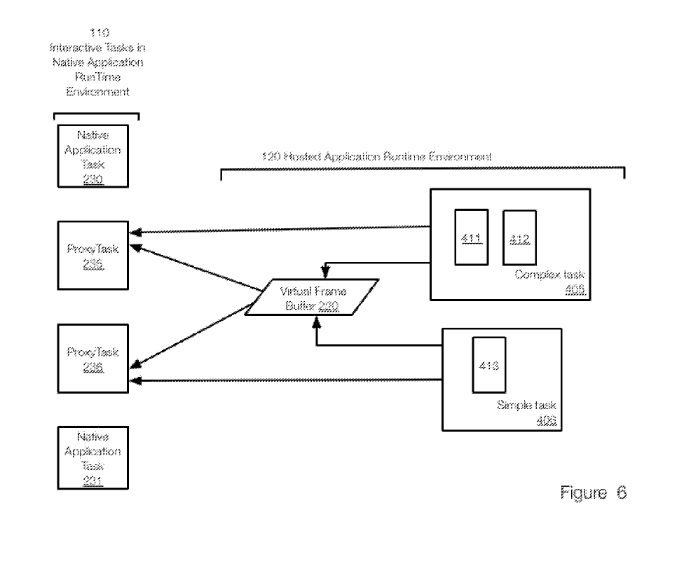

As shown in FIG. 6, hosted application runtime environment 120 further comprises a task 405 operating in accord with the complex task model and having two processes 411, 412, and a task 406 operating in accord with the simple task model and having one process 413). Regardless, in the illustrated embodiment, each of the tasks 405, 406 is associated with one proxy (or client) task 235, 236 respectively, and also associated with one hosted application 205, 206 respectively.

Together, the proxy (or client) tasks 235, 236, the task models 405, 406, the hosted system of drawing 210, windowing 212, and compositing 215 modules, and the virtual frame (or screen) buffer 220, provide the following functions: (i) enabling the hosted application tasks 205, 206 to run as background tasks within the native application runtime environment 110; (ii) enabling the hosted application runtime environment's 120 foreground status to be abstracted from the operation and semantics of the task management system in the native application runtime environment 110; and (iii) integrating and coordinating the operation of the hosted application runtime environment 120 and the native application runtime environment 110 such that the user cannot discern any differences between the functioning of the native application tasks 230, 231 and the hosted application tasks 205, 206.

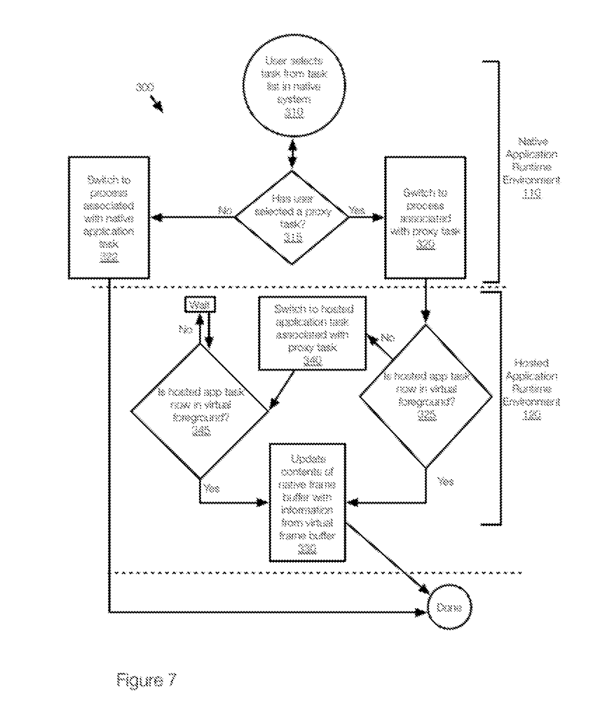

FIG. 7 illustrates the method of switching between interactive tasks and, more particularly, of coordinating foreground/active tasks, as between the native and posted runtime environments, in accordance with a preferred embodiment of the invention. In particular, FIG. 7 illustrates how the task displayed in the virtual frame buffer 220 of the hosted application interface environment 120 is coordinated with its corresponding proxy task and the foreground task of the native application runtime environment 110.

In step 310, the user selects an interactive task from the task list in the native system.

Both native application tasks 230, 231 and proxy tasks 235, 236 (as stated above and shown in FIG. 6, proxy tasks 235, 236 are tasks within the native application runtime environment 230 that act as proxies for hosted application tasks 205, 206 respectively), are available in the task list for selection by the user. At step 315, the method determines whether the user has selected a proxy task or a native application task. Proxy tasks are distinguished from native application tasks by convention. Any property where a value or a string can be modified can be used, by convention, to identify a proxy task. In a preferred embodiment, task names are used to distinguish between proxy tasks and native application tasks, although this is not a limitation of the invention.

If the user selects a native application task (i.e., one of 230, 231) at step 315, the method proceeds to step 322. At step 322, the native application runtime environment 110 switches to the process associated with the selected native application task, and brings the selected native application task to the foreground of the native application runtime environment 110.

Alternatively, if the user selects a proxy task (i.e., one of 235, 236) at step 315, the method proceeds to step 320. At step 320, the native application runtime environment 110 switches to the process associated with the selected proxy task (e.g., as discussed elsewhere herein)** and brings the selected proxy task to the foreground of the native application runtime environment 110.

At this point, the task switch has occurred in the native application runtime environment 110, and may need to be propagated to the hosted application runtime environment 120. At step 325, the method determines whether or not the task switch needs to be propagated to the hosted application runtime environment.

At step 325, the method determines whether the hosted application task is in the virtual foreground of the hosted application runtime environment 120. This determination is made using information obtained by the proxy task 235, 236 about the state of the virtual frame buffer 220 in the hosted application runtime environment 120. Specifically, the proxy tasks monitor the state (foreground or background) of the hosted application tasks.

If the hosted application task is in the virtual foreground of the hosted application runtime environment 120, the task switch does not need to be propagated, and the method proceeds to step 330. At step 330, the hosted application task's view of the virtual frame buffer 220 is updated to the native frame buffer 260. At this point, the hosted application task is in the foreground, and the user will be able to view and make use of the user-selected task. The seamless transition allows the user to view the hosted application task 205, 206 as if viewing a native application task.

Referring again to step 325, if the hosted application task is not in the virtual foreground of the hosted application runtime environment 120, the task switch needs to be propagated, and the method proceeds to step 340. At step 340, the hosted application runtime environment 120 switches to the hosted application task 205, 206 associated with the proxy task 235, 236 as described in step 320.

At step 345, the method determines whether the hosted application task 205, 206 is now in the virtual foreground of the hosted application runtime environment 120. If the hosted application task is not in virtual foreground of the hosted application runtime environment 120, the method waits until the hosted application task moves to the virtual foreground of the hosted application runtime environment 120. At this point, the method proceeds to step 330, as described above.

Notification and Reply Adaptation for Hosted Applications in Multi-Operating System Mobile and Other Computing Devices

As noted above, another example of the illustrated computing device's 10 merging the user experience so that applications executed in the hosted runtime environment appear, to the user, as if they are executing within the native operating system 14 is the use of a common notification mechanism, e.g., that of the native operating system 14 and/or runtime environments 16.

An understanding of how this is effected may be attained by reference to the discussion that follows, in which
It will be appreciated that, as a general matter of background, some computer operating systems have notification systems, where applications native to those operating systems post notifications. Users can interact with those notifications, and the interactions are conveyed to the applications that posted those notifications. Unlike applications, notification systems are singletons—there is one per (operating) system;
In the illustrated embodiment, the foregoing is likewise true of the native operating system 14 and, more particularly, of the native runtime environment 16—there is a single notification subsystem that is common to all executing native software applications;
In the illustrated embodiment, the foregoing is likewise true of the hosted operating system and, more particularly, of the hosted runtime environments 32—there is a single notification subsystem that is common to all executing hosted software applications;
The native and hosted operating systems are assumed to have diverse implementations of notification systems: Each might have a different set of standard prompts, visual indicators, and interprocess messages, on different interprocess message systems, used to notify applications of user interactions with notifications;
It is assumed that it would be confusing to the user of device 10 if notifications were presented from two different notification systems, e.g., some from the notification subsystem of the native operating system and some from the notification subsystem of the hosted operating system;
Although a differing elemental numbering scheme is used, like names are used for like components discussed above and shown in FIGS. 1-7

Described below is a mechanism for enabling hosted applications to use and interact with native system notification subsystems.

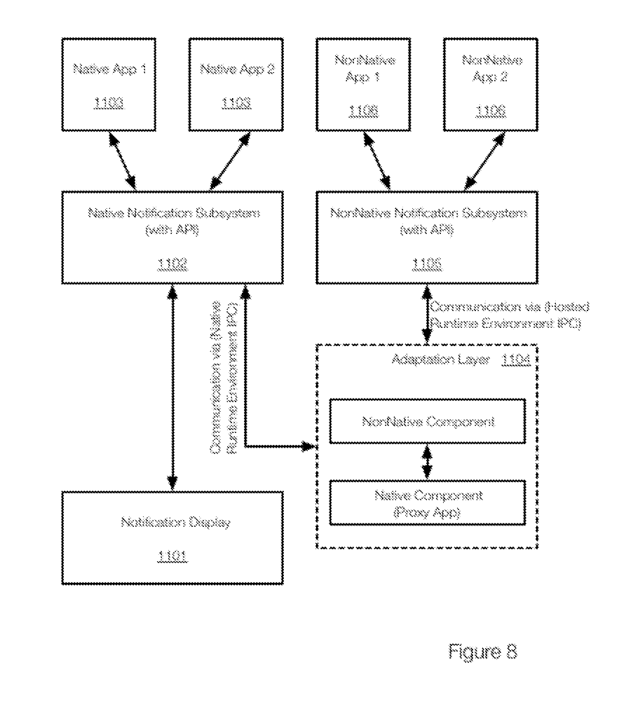

Referring to FIG. 8, native operating system 14 has a notification subsystem 1102 that provides a visual display of notifications 1101. Applications 1103 post notifications, using an API of subsystem, 1102, and, optionally, can interact with notifications by specifying that they be notified of touches and other user actions through that API, which may use inter-process communication to convey the information about interactions to the application.

Similarly, hosted runtime environments 32 provides a notification subsystem 1105 that is employed by hosted (nonnative) apps 1106. Those applications post notifications, using an API of subsystem 1105, and, optionally, normally interact with notifications by specifying that they be notified of touches and other user actions through that API, which may use inter-process communication to convey the information about interactions to the application.

When a runtime environment for applications designed for a different operating system, or a cross-platform runtime environment that integrates with native-environment notifications is added to and operating system, an adaptation layer 1104 can be used to translate notifications between the two systems.

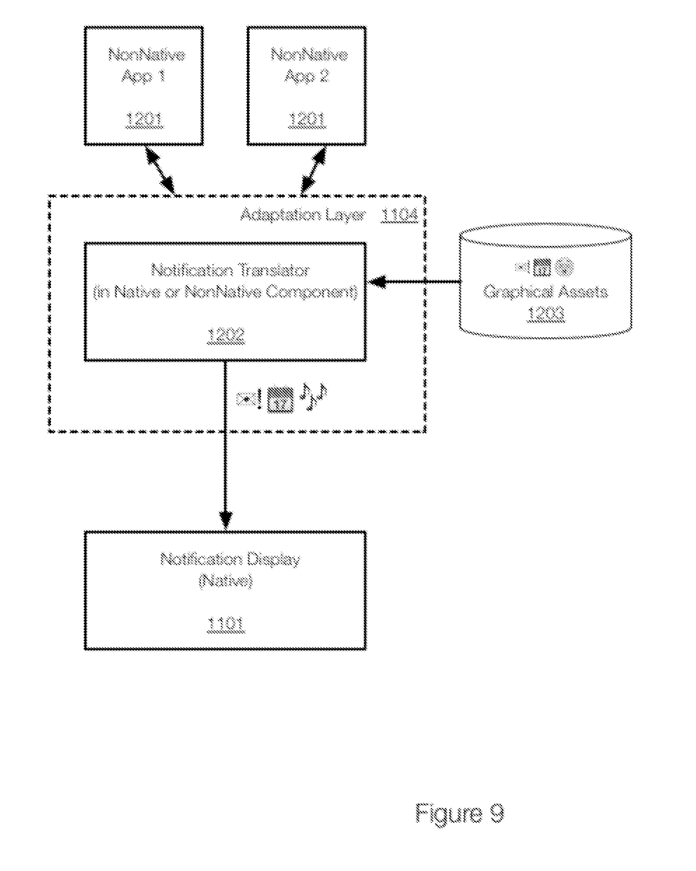

The adaptation layer 1104 provides the following functionality to facilitate adaptation:
The semantics of notification: If, for example, in the native OS, an application is brought to the foreground when a notification is acknowledged by the user, the semantics of this interaction are appropriately translated into actions on tasks in the hosted non-native environment. In the illustrated embodiment, this is effected in a manner like that shown in the FIG. 8 and discussed above in connection with coordinating foreground/active tasks as between the native and hosted runtime environments.
Interfaces: If the native environment uses a different inter-process communications mechanism (IPC) than the hosted non-native environment, the adaptation layer uses the native inter-process communications system and is a proxy for non-native applications to the native environment, and uses the non-native IPC mechanism to communicate with the non-native applications 1106.
Graphical assets: Referring to FIG. 9, if a non-native application 1201 uses the non-native API and thereby the notifications translation layer 1202 of the adaptation layer 1104 to post a notification, and if that notification either lacks a corresponding graphical asset in the native environment, non-native graphical assets 1203 that are included in the hosted runtime environment or non-native applications will be used, and, if necessary, converted to a format displayable in the native environment visual display of notifications 1101. The translation layer 1202 can be implemented in the native component and/or the non-native component of the adaptation layer 1104, as needed.

In the illustrated embodiment, adaptation layer 1104 has a non-native component and a native component which provide the aforementioned functionality. The non-native component has instructions for execution under the hosted operating system and executing on the central processing unit within one of more of the hosted runtime environments. It can communicate With the hosted notification API via the hosted IPC protocol. The native component has instructions for execution under the native operating system and executing on the central processing unit within one of more of the native runtime environments. It can communicate With the native notification API via the native IPC protocol.

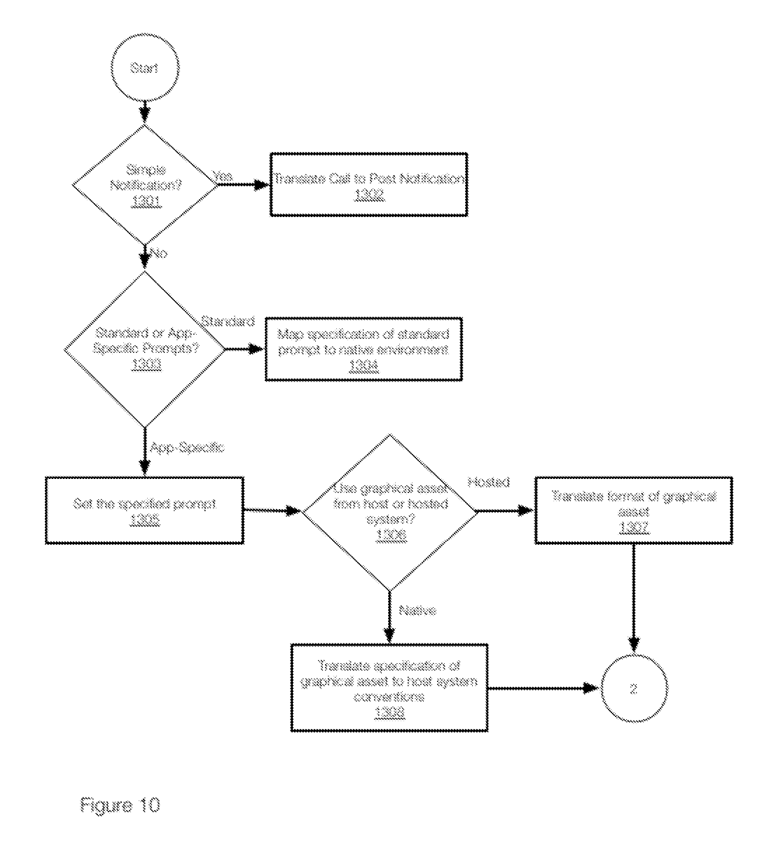

Referring to FIG. 10, when an application 1201 in the hosted, non-native environment posts a notification, the adaptation layer decides if the hosted application is posting a simple notification 1301, without graphical assets, standard prompts that need to be mapped, or a return message. If that is the case, the parameters of the hosted system's method are translated to the corresponding parameters in the host system, and the notification is posted 1302.

If the notification is not simple, then it is determined if the application is posting a notification with standard, predetermined prompt text, or with a prompt that is application-specific 1303. If the notification being posted uses a standard prompt with a counterpart in the host system, the reference to that prompt is mapped to a reference to the counterpart in the host system 1304.

If the prompt is application-specific, or if there is no counterpart to a standard prompt in the host system, the prompt text is passed to the host system to be used in the call to post the notification 1305. If there are graphical assets such as a notification icon in the notification and the asset to be used is from the hosted system 1306 any necessary format conversion is performed 1307. If a graphical asset from the host system is to be used in the notification, the specification or reference to the graphical asset is translated into one used in the host system 1308.

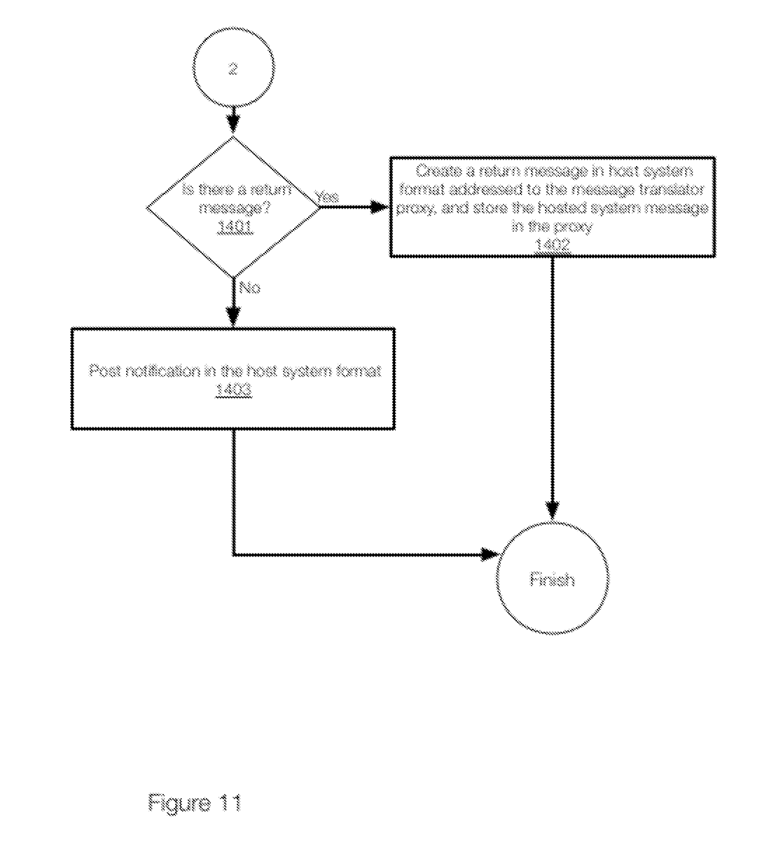

Referring to FIG. 11, if there is a message (in the hosted environment's inter-process communication (IPC) system's format) attached to the notification, to be delivered based on the user's interaction with the notification 1401, that message is registered with a proxy program with an interface to the host system's IPC system, and a message addressed to this proxy program containing a reference to the hosted system's reply message. Now the notification containing:
a prompt text, or a reference to a standard prompt in the host system,
any graphical assets that go with the message or references to host system graphical assets, and,
if present, a reply message that will be delivered to a proxy program that stores the hosted system's reply messages,

is posted 1403 to the host system's notification system.

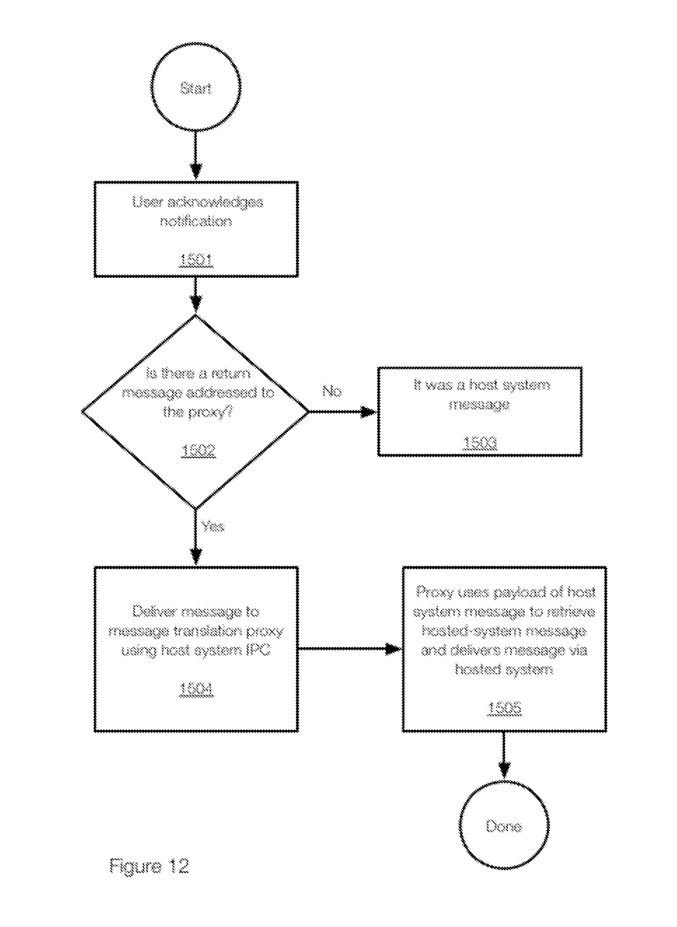

Referring to FIG. 12, if the user interacts with the notification 1501, and if the notification return message is not addressed to the proxy 1502, it is a notification for host system applications, and is processed as usual in the host system 1503. If the return message is addressed to the proxy for return messages, it is delivered to the proxy using the host system's inter-process communications mechanism 1504. The proxy uses the reference contained in the return message to find a return message registered with the proxy when the notification was posted, and this message is delivered to the hosted application, using the hosted system's IPC mechanism, as if it were sent by the hosted system's notification system 1505.

Host/Hosted Hybrid Apps in Multi-Operating System Mobile and Other Computing Devices

In other embodiments of the invention, the illustrated computing device 10 more fully merges the user experience by executing, within a single application address space, instructions comprising a hosted software application (e.g., hosted software application 34) along with instructions from the native runtime libraries 20 and/or other resources of the native runtime environments 16. Also included within that application address space can be instructions from the hosted run-time libraries 44 and/or other resources of the hosted runtime environments 32. The device 10 accomplishes this, inter alia, by linking and loading that hybrid collection of instructions into CPU (and RAM) for execution by using two linker-loaders: one for the hosted instructions and one for the native instructions, yet, both executing in the native runtime environments 16. This assumes that, although the hosted and native operating systems differ (e.g., as discussed elsewhere herein), the instructions of executables of both are suitable for execution on a like CPU—particularly, that of device 10.

Executing instructions of hosted software application 34, hosted and native runtime libraries, etc., as a hybrid application in this manner (i.e., in a single application address space) has advantages, among others, of decreasing overhead incurred in executing hosted software applications and improving the consistency of the user experience as between hosted and native software applications.

Hybrid Application

FIG. 13 depicts a hybrid collection of instructions 2000 for execution a single application address space—or, more simply put, execution of a “hybrid” application 2000—according to some embodiments of the invention.

Referring to the drawing, application 2000 executes on the CPU of device 10 within the native operating system 14. In the illustrated embodiment, the application 2000 and, more particularly, that collection of instructions is created and loaded for execution into the CPU (and RAM) of device 10 (as if it were simply comprised of instructions from a native software application and native runtime resources necessary thereto), e.g., through action of linking loaders 2002, 2004, here, labelled, native linking/loader and hosted linking/loader, respectively.

Launch Proxy/Bootstrap Stub

In the illustrated embodiment, creation and loading is initiated, for example, upon the user's selection for activation of the launch proxy 46 corresponding to the hosted software application 34 to be executed. Unlike in the embodiments discussed above (e.g., in connection with steps 66, et seq.) in which, upon launch, proxy 46 effects activation of corresponding hosted software application 34, here, creation, loading and execution of application 2000 is effected as discussed below.

The proxy 46 of the illustrated embodiment comprises code, referred to, here, as a “bootstrap stub,” that includes:
1. Instructions to link and load and execute the hosted software application 34 executable using the hosted linker/loader 2004 and, then, to execute the hosted software application 34.
2. References to one or more libraries (referred to as “adapted” libraries) containing at least selected classes and/or functions (collectively, “functions” for sake of simplicity and without loss of generality) of hosted run-time libraries 44 and/or other resources of the hosted runtime environments 32 (collectively, “hosted run-time libraries 44” for sake of simplicity and without loss of generality) called and/or potentially called by the hosted software application 34 executable.
3. References to one or more libraries containing other functions, if any, of the hosted run-time libraries 44 called and/or potentially called by the hosted software application 34 executable.
4. References to one or more native runtime libraries 20 and/or native runtime environments 16 resources.
5. Instructions for executing the hosted linker/loader 2004 with native runtime environments 16 to link hosted software application 34 and to resolve references therein using (1)-(4).

In some embodiments, rather than such references, the stub can include inline versions of (1)-(4), or a subset thereof, consistent with the teachings hereof. Of course, not all of these need be included in the bootstrap code. For example, code corresponding to item (3) and, potentially, items (2) and (3) may be absent from any particular stub.

In the illustrated embodiment, a proxy 46 comprising such code can by request from ACL 18 to native operating system 14, in connection with the installation by ACL 18 of respective hosted software application 34, e.g., consistent with the discussion above in the section entitled “Native and Hosted Software Application Installation.”

Libraries for Linking/Loading with Bootstrap Stub

The libraries referred to in (2), above, of the illustrated embodiment are adapted from conventional run-time libraries 44 of the type available in the marketplace for use under the hosted operating system and, particularly, in which at least the selected functions are modified to interface with and to utilize corresponding and/or other functions provided in native runtime libraries 20 and/or native runtime environments 16 resources. In other embodiments, some or all of those “adapted” libraries can be adapted from conventional runtime libraries 20 of the type available in the marketplace for use under the native operating system 14 and, particularly, in which at least selected functions are modified to intercept calls from the hosted software application 34 as if part of the hosted run-time libraries 44.

While those “selected” functions can include any or all functions referenced within hosted software application 34—and, indeed, can include any or all functions (regardless of whether referenced by hosted software application 34) provided within hosted run-time libraries 44—in the illustrated embodiment, the selected functions are those functions of hosted run-time libraries 44 whose execution can be more efficiently and/or beneficially executed, at least in whole or part, using from the native runtime libraries 20 and/or other resources of the native runtime environments 16. This includes, by way of nonlimiting example,
functions which, if executed on behalf of hosted software application 34 wholly in the manner conventional to the hosted operating system or hosted run-time libraries 44, might conflict with similar functionality executed within the single application address space 2000 by functions of the native runtime libraries 20 and/or other resources of the native runtime environments 16. Such functions include those for memory allocation (e.g., malloc), thread local storage, pthreads, and so forth. With respect to these functions, the adapted libraries preferably include code that is adapted from the native runtime libraries 20 so as to (i) to intercept calls from the hosted software application 34, and (ii) in the case of memory allocation functions, particularly, malloc, for example, to utilize the malloc function of the native runtime libraries 20 in lieu of that of the hosted runtime libraries 44, (iii) in the case of application threading functions, particularly, pthreads, for example, to emulate the hosted runtime library functions albeit in a manner expressible in context of native runtime library thread management, and (iv) in the case of thread local storage functions, particularly, for example, TLS, parlaying information maintained in individual entries of the vector maintained by TLS of the native runtime libraries 20 (for purposes of managing threads of individual native applications) to manage multiple threads of the hosted software application 34, all by way of nonlimiting example.
functions which can be more effectively executed utilizing hardware-specific and/or other optimizations and/or other coding features provided by the native runtime libraries 20 and/or other resources of the native runtime environments 16. Such functions include those for graphics acceleration and, more generally, for interfacing with hardware devices 24-30 integral or attached to device 10. With respect to these functions, the adapted libraries preferably include code that is adapted from the hosted runtime libraries 44 so as to (i) to redirect calls from the hosted software application 34 to more efficient and/or better optimized functions provided by the native runtime environments 16 and native runtime libraries 20.

The other functions of the hosted run-time libraries 44 referred to in (3), above, are those functions of conventional hosted run-time libraries 44 (i.e., conventional run-time libraries 44 of the type available in the marketplace for use under the hosted operating system) whose execution is not necessarily more efficiently and/or beneficially effected using from the native runtime libraries 20 and/or other resources of the native runtime environments 16. Examples include mathematical and other computationally-based functions.

The native linking/loader 2002 can be a link/loader of the type conventionally available in the marketplace (as adapted in accord with the teachings hereof) for linking and loading native software applications for execution on device 10 under hosted operating system 14. Hosted linking/loader can be of the type conventionally available in the marketplace for linking and loading hosted software applications for execution under the hosted operating system, albeit as adapted in accord with the teachings hereof for execution within native runtime environments 16.

Operation

FIG. 14 is a flow chart depicting operation of device 10 in creating and executing a hybrid application 2000 in native runtime environments 16.

Referring to step 2010, upon selection of proxy 46 by the user for launch (or other notification of activation from native runtime environments 16 and/or native operating system 14), native linker/loader 2002 loads general functions necessary for application execution under native operating system 14, e.g., functions of the native runtime libraries 20 and/or other resources of the native runtime environments 16 necessary to allocate allocate and manage memory, threads and so forth, by way of nonlimiting example.

In step 2012, native linker/loader 2002 accesses the hosted linker/loader 2004, links and loads it for execution. This includes resolving references made in the code of linker/loader 2004, e.g., by linking referenced functions from the native runtime libraries 20. To the extent that code references functions of the hosted run-time libraries 44, this includes linking the adapted runtime libraries 2008, and, then, the native runtime libraries 20, so as to insure that the adapted libraries 2008 are used in preference to the conventional hosted run-time libraries 44 and to insure that any still unresolved references are satisfied by the native runtime libraries 20.

In step 2014, once the hosted linker/loader is executed, the native linker/loader 2002 relinquishes control to native operating system 14 and/or native runtime environments 16 to commence execution of the hybrid application 2000 in native runtime environments 16, beginning with the instruction to link and load the hosted software application 34 executable using the hosted linker/loader 2004. This causes the hosted linker/loader 2004 to access the hosted software application 34 executable, and to link and load it for execution. As above, this includes resolving references made in that code by linking it, first, to the code of the adapted libraries 2008, then, to the code of the hosted run-time libraries 44. The hosted linker/loader 2004 can also link the native runtime libraries 20 to resolve any final unresolved references.

Referring to step 2016, the executing hybrid application 2000 next executes instructions causing the linked/loaded hosted software application 34 to execute within the native hardware environment of device 10 under the native operating system 14, using functions both from the native runtime libraries 20, the adapted libraries 2008 and the hosted run-time libraries 44.

### Graphics Acceleration

Overview

As noted above, hosted software application 34 runs in the conventional manner within hosted runtime environments 32—e.g., making such calls to the hosted resource framework 38, hosted event handler 42 and run-time libraries 44, all by way of non-limiting example—as it would otherwise make if it were installed on a device executing a single operating system of the type of the hosted operating system. Hosted resource framework 38, hosted event handler 42, run-time libraries 44, and the other components of hosted runtime environments 32 respond to such calls in the conventional manner known in the art of operating systems of the type of hosted operating system, all as adapted in accord with the teachings hereof.

In some embodiments, by way of example, in lieu of loading an actual frame buffer with graphics defining an applications window representing execution of the hosted software application 34, the hosted runtime environment 32 loads the virtual frame buffer 54 with such graphics. See, step 72. The hosted runtime environment 32 effects this through use of the windowing and graphics subsystems that form part of the hosted runtime environment 32 and that is common to the one or more hosted software applications 34, 36 (e.g., in that it is the common, shared system used by the hosted software applications for generating applications windows for display to the user of device 10.) The IO proxy 50 of hosted software application 34 effects presentation on screen 24 of the applications windows generated for application 34 by hosted runtime environments 32, e.g., in the manner shown in FIG. 1C and discussed in connection therewith above. See, step 74. IO proxy 50 does this by transferring the graphics defining that applications window from virtual frame buffer 54 to the native frame buffer 26, e.g., using an API provided by native runtime environments 16 for such purpose or otherwise.

Instead of using the IO proxy 50 to effect presentation of graphics generated by application 34 on screen 24, in some embodiments application 34 effects this through more direct use of resources native to device 10. Those resources can include, for example, use of a graphics processing unit (not shown) native (or otherwise coupled) to device 10, e.g., as a companion to the central processing unit (CPU) depicted in FIGS. 1A. Those resources can also include, for example, use of the native runtime environment(s) 16 (including, kernel 24, application resources 19 and/or runtime libraries 20) and the native graphics subsystem and/or native windowing subsystem forming part of those environments 16, or otherwise, as discussed further below to accelerate execution of at least certain instructions and/or operations of the host software application 34.

Referring to FIG. 3 and by way of overview, in order to effect generation of three-dimensional display graphics (e.g., graphical windows or portions thereof representing visual sequences of games or other graphics applications), hosted software application 34 executes instructions that invoke, directly or indirectly, a hosted graphics subsystem and a hosted windowing subsystem that are common to the hosted software applications 34, 36. Together, these are referred to occasionally herein as a “hosted graphics framework.”

The hosted graphics subsystem of the illustrated embodiment comprises a subset of the runtime libraries 44 and/or framework 38 that present interfaces (APIs) and provide functionality in accord with the OpenGL ES standard of Khronos Group and its EGL windowing system interface, all as adapted in accord with the teachings hereof. In other embodiments, the hosted graphics subsystem may present interfaces and/or functionality in accord with other standards, in accord with proprietary protocols or otherwise.

The hosted windowing subsystem of the illustrated embodiment likewise comprises a subset of the runtime libraries 44 and/or framework 38 that creates, manages and presents on display 24 (e.g., via frame buffer 26) windows or frames (as well, optionally, as menus, icons, etc.) that form a graphical user interface in which graphics generated by the application 34 (or applications 34, 36) via the graphics subsystem are presented.

The native software applications likewise execute instructions that invoke, directly or indirectly, a native graphics subsystem and a native windowing subsystem that are common to them (i.e., the native software applications), e.g., as shown in FIG. 2. Together, these are referred to occasionally herein as a “native graphics framework.”

The native graphics subsystem of the illustrated embodiment comprises a subset of the native application resources 19, runtime libraries 20, and/or kernel 22. As above, that graphics subsystem present APIs and provide functionality in accord with the OpenGL ES or other protocol (industry-standard or otherwise) and a complimentary interface to the windowing native to the operating system 14, again, all as adapted in accord with the teachings hereof.

The native windowing subsystem of the illustrated embodiment likewise comprises a subset of native application resources 19, runtime libraries 20, and/or kernel 22 that creates, manages and presents on display 24 (e.g., via frame buffer 26) windows or frames (as well, optionally, as menus, icons, etc.) that form a graphical user interface in which graphics generated by the application 34 (or applications 34, 36) via the graphics subsystem are presented.

While the host and native graphics subsystem can be based on like protocols (e.g., OpenGL and EGL), they need not be. This is likewise true of the host and native windowing subsystems. Significantly, however, whereas the native graphics subsystem and the native windowing subsystem are typically adapted to exploit the GPU and other hardware and/or software resources of device 10 (and more directly coupled to them), e.g., in order to rapidly display graphics generated by the native software applications, the hosted graphics subsystem and the native windowing subsystem are not typically so adapted. Some embodiments of the invention remedy that by placing the “hosted graphics framework” and the “native graphics framework” in cooperation as discussed below and elsewhere herein, e.g., to accelerate execution of at least certain instructions in the hosted software applications using the GPU (and/or other graphics-related resources) of device 10.

By way of overview, the native graphics framework responds to certain instructions executed by the native software applications by populating respective off-screen pixmap or other buffers allocated by the EGL (or other native graphics interface) component of that framework with graphics. And, a native compositor that also forms part of the native graphics framework generates a composite graphic from such buffers and transmits that graphic (e.g., to frame buffer 26) for presentation on the display 24. As part of the aforesaid cooperation, the EGL (or other native graphics interface) component of the native graphics interface creates an off-screen buffer and passes at least an identifier of that buffer to the hosted graphics framework to be populated with graphics by it in response to instructions executed by the hosted software applications.

A compositor that forms part of the hosted graphics framework generates a composite graphic from one or more off-screen buffers assigned to it by the native graphics framework in connection with graphics generated in response to instructions executed by one or more of the hosted software applications, e.g., 34. The hosted graphics framework and the native graphics framework cooperate to transfer the composite graphic to at least one of the graphics processing unit and the frame buffer 26 for presentation on display 24. That composite graphic, itself, can be transferred by way of an off-screen buffer allocated by the EGL (or other native graphics interface) component of the native graphics framework and passed to the hosted graphics framework.

As further discussed below, parallel mechanisms can be employed by the native and hosted graphics frameworks to transfer to display 24 two-dimensional graphics generated by hosted graphics framework in response to instructions executed by the hosted applications.

A more complete understanding of practice of the invention may be attained by reference to the discussion that follows, which discusses an embodiment of a device 10 that runs a particular operating system—here, the Tizen operating system and its associate runtime environments—and that uses the resources of that device, operating system and runtime environments to accelerate graphics generated by hosted software applications 34, 36 built and intended for execution under another particular operating system—here, an Android operating system. Correspondence between the terms used below and those used elsewhere herein will be readily evident to those of ordinary skill in the art. Thus, for example, the term “host” is typically used below in reference to the native operating system 14, runtime environments 16, etc., while the term “native” is used as evident in context.

More particularly, discussed below is use the Android runtime environment 32 to run unmodified Android applications 34, 36 in a manner that they both integrate seamlessly with, and take advantage of, the functionality exposed by, the host operating system 14. One area of particular interest in this regard is 3D graphics and, particularly, enabling the Android applications 34, 36 to take advantage of the hardware acceleration provided by a GPU provided on device 10 through the host OS 14.

Unless otherwise specified, all filenames provided for reference are relative to the android/frameworks/base repository.

Embodiments without Hardware Graphics Acceleration

Before discussing embodiments of device 10 that use host hardware support (e.g., the GPU of device 10), as well as other resources of the native (host) operating system and runtime environments, to accelerate graphics generated by hosted software applications 34, it is useful to review operation of embodiments that do not take advantage of such acceleration.

Surfaces and Buffers

A buffer is essentially an image: a collection of pixels. Surfaces sit one level above buffers, containing them. The most common use of surfaces is as an application window. The window and surface have many external properties (e.g. input handling), but are also associated with one or more buffers. Typically, there are two buffers: a back buffer, not shown on screen, which the application is actively rendering new content to, and a front buffer, containing a set of completed rendering, which is being shown on screen as the window's current content.

While surfaces and buffers are strongly related, they are in fact conceptually separate.

Compositing

Compositing is the process of combining multiple buffers and painting them together to produce a coherent image. Whereas early window systems involved multiple clients drawing to the same buffer, which was displayed directly on screen (the framebuffer), modern window systems have clients paint directly to their own full-size buffers for each window, with the display server (e.g. the X server or SurfaceFlinger) combining these buffers to render the final display.

Gingerbread

While Android is now a full-fledged modern OS, its Gingerbread (2.3) release from 2010 was still very much in its infancy. In particular, its graphics support was rather nascent and strongly encouraged 3D applications to bypass the window system completely and display direct to the hardware.

Implementations without Host Hardware Support

As discussed in a prior section, hosted linking loader 2004 runs in the address space of, and is linked with libraries from, the standard host OS. The loader is able to interpret Android binaries, and either direct the calls they make to the Android libraries installed by the OpenMobile system, pass them to the host OS libraries, or intercept them and execute its own code in place of these OS routines.

Embodiments without host hardware acceleration have functional support for Android applications using OpenGL ES and EGL to render their user interface, of which Angry Birds is the most prominent example. These implementations uses the reference Android implementations of OpenGL ES and EGL, which are purely software-based. ACL intercepts application requests to display the back buffer (the eglSwapBuffers routine), and in response to this request, copies the contents of the current back buffer into an X11 window inside the host OS, through XPutImage.

This allows Android applications using 3D rendering APIs to run unmodified under ACL, however it does not make use of any 3D acceleration provided by the hardware, and also incurs a number of copies along the way to being displayed on screen.

OpenGL ES

OpenGL ES is a 3D rendering API from Khronos, which is standardised across all manner of devices. Whilst OpenGL ES 1.x provided a deeply inflexible model in which applications were only able to render exactly what had already been specified and implemented, OpenGL ES 2.x provides a fully programmable model. Vertex and fragment programs (collectively ‘shaders’), provide a powerful C-like language which allows the application to programmatically direct all rendering.

OpenGL ES 2.x has been standard in consumer devices since approximately 2009, when the iPhone 3GS shipped with the PowerVR SGX, along with a number of higher-end Android, Symbian and generic Linux smartphones in the same price range. Since then, OpenGL ES 1.x has rapidly disappeared; even the most low-margin feature phones have shipped with OpenGL ES 2.x for the past couple of years.

This has been paralleled by a similar shift in how GPUs have been used. The OpenGL ES 1.x model was based around heavy geometry usage (triangles/polygons: essentially a wireframe model), with solid-colour shading of each element. While sufficient for basic graphics, it falls apart both for games with more detailed graphical assets, and for 3D compositing of large images (texture dimensions limited to an exact power-of-two each).

OpenGL ES 2.x introduced a much stronger reliance on large textures, and flexible sampling from those textures. Whilst this was initially quite painful (an experience borne out by Collabora's work on many early OpenGL ES 2.x devices using 3D compositing, including years of work on the Nokia N900 and N9), modern GPUs have adapted and now place a much stronger emphasis on flexible and fast sourcing from textures.

However, OpenGL ES does not and cannot exist in a vacuum.

EGL

EGL is the window system integration for rendering APIs such as OpenGL ES, whose role is essentially to provide context. Rendering APIs do not have any interaction with the outside world in and of themselves: they have a limited number of buffers provided to them, and their sole function is rendering within those buffers.

By providing integration with the outside window system (such as X11), EGL is able to both initially provide OpenGL ES with buffers to render into, and finally transfer the results to the final display. EGL does not provide complete integration with the window system: in particular, it does not provide any events, so applications are responsible for ensuring that input is handled separately, as well as window resizing.

EGL provides a Context, containing the current rendering API in use (e.g. GL ES 1.1, or 2.0), and the surface which is currently being used for rendering. Each thread may have exactly one context bound at any time, thus it is always possible to determine without any additional information or function arguments, all current rendering-related state.

In terms of rendering, EGL provides three types of greater interest: Surfaces, Images, and Configs. Surfaces (as defined in Surfaces and buffers) are analogous to windows, and are a collection of buffers; Images are essentially individual buffers. Through its integration with related rendering APIs such as OpenGL ES (the two are inseparable, and it is impossible to combine one vendor's EGL implementation with another's OpenGL ES implementation), EGL provides the rendering API with buffers for the window system's surfaces. This is, however, purely an implementation detail: users of OpenGL ES and EGL cannot discover any details about the individual buffers being used in rendering to a surface.

Configs fully describe the pixel format used by a particular surface: the depth of the colour channels and resultant bits per pixel value, the conditions under which the config is usable (such as whether it is usable with windows and/or pixmaps), and information about ancillary buffers such as depth and stencil buffers.

EGL requires that applications create their own connections to the window system, and from that, create their own windows. The eglGetDisplay and eglCreateWindowSurface entrypoints both take ‘native’¹ types, which are both opaque and platform-dependent. On X11 systems, the types are assumed to be a pointer to an open X11 display, and the ID of a client-created X11 window, respectively. ¹Again, host-provided types and functions are referred to ‘host’ rather than ‘native’, regardless of the EGL nomenclature.

On Android systems, the display type is largely ignored, but the window type is a pointer to an abstract class² named ANativeWindow. Implementations of this class provides a number of methods, allowing the EGL implementation to be a lightweight wrapper around ANativeWindow, and for users to essentially provide their own window system support without in-depth modification to the entire graphics stack. ²Strictly speaking, a C structure, often wrapped by a C++ class.

Skia

Skia is Android's 2D graphics library, similar to both canvas-based APIs such as Cairo, and software compositing libraries such as Pixman. Gingerbread's Skia implementation does not attempt to take advantage of any hardware acceleration, and is thus relatively simple to handle: it renders directly to CPU-accessible memory.

It is typically accelerated through use of ARM'S NEON SIMD instructions, but does not place any particular demands on the graphics subsystem.

X11

X11 has been the dominant window system in use on Unix-based systems since the mid-1980s. X, as it is known, provides a client/server architecture where the server provides the clients resources such as windows and input events. It also offers multiple rendering APIs of its own, which allow the server to render on the client's behalf, and inter-process communication between graphical clients (including the window manager and applications).

One of X's core design principles is ‘mechanism, not policy’. Simply put, both the protocol and the reference implementation (no alternative implementations are widely used) aim for maximum flexibility, a model in which capabilities can be added by simply interchanging clients, without any awareness in the protocol or server. This model can be powerful, particularly in the era it was designed where vendors were unwilling or unable to update the server to allow for new capabilities, but also has its downsides.

Nevertheless, X continues to be strongly used up until the current day, including as the display server in Tizen (Phone and PC; IVI uses Wayland), MeeGo-Harmattan, and others.

SurfaceFlinger

SurfaceFlinger is the Android window system, modelled closely on both the EGL API and its typical implementation. It provides surfaces to clients requesting them, and also provides buffers for clients as well (e.g. in response to ANativeWindow's dequeueBuffer call).

SurfaceFlinger is mostly restricted to pure compositing (rather than rendering), which in the Gingerbread implementation is provided through OpenGL ES. Anything requiring policy or user interaction—such as window stacking/layering and positioning—is provided through auxiliary services such as WindowManager and ActivityManager.

Communication with its clients flows through the Binder IPC mechanism, including provision of buffers.

Android EGL and OpenGL ES

Traditionally, GPU vendors have provided their own complete OpenGL ES and EGL implementations, which are dropped into the system root and used directly by applications and toolkits. This results in unfortunate variations between vendors, where differing implementations produce differing results for seemingly valid input.

Android has aimed to solve this problem by providing a generic EGL wrapper which provides all externally-visible EGL entrypoints and interactions, calling into vendor-provided code only when needed. This EGL wrapper performs all hardware-independent interactions—such as anything associated with the window system—from generic Android code, calling into hardware-dependent code with a well-defined API only where strictly necessary.

This EGL implementation provides its own window system-like types, which are actually both independent of the actual window system used, and extensible by both applications and utility libraries alike. The EGLNativeWindowType for the Android EGL platform is ANativeWindow, an abstract C type containing a number of function pointers which are responsible for passing buffers (of type android_native_buffer_t) to between the underlying window system, and the GL ES renderer.

The typical implementation of ANativeWindow is the SurfaceFlinger backend³, which uses Android's Binder IPC mechanism to transfer buffers between client and server. It is not a particularly complex implementation, and does nothing surprising beyond what the function names imply. An alternate implementation is provided by the FramebufferNativeWindow class, which allows applications to bypass SurfaceFlinger and render directly to the display. ³libs/surfaceflinger_client/Surface.cpp

Three functions of greater interest provided by ANativeWindow are dequeueBuffer, lockBuffer, and queueBuffer. In order of typical usage, dequeueBuffer obtains a buffer (of android_native_buffer_t C type, wrapped by a GraphicBuffer C++ class; this contains a native_handle-typed handle to the actual storage) from the window system for the client to render into; lockBuffer creates a CPU-visible mapping for the buffer for use by, e.g., Skia; finally, queueBuffer injects the buffer into the window system for display once the client has finished its rendering.

The Android graphics environment is also rather unique in that it can dynamically switch between the hardware-accelerated backend and its own software-based implementation (AGL), at runtime, as well as switching between GL ES versions. Depending on the EGL context in which they were called, function calls can sometimes end up in both implementations.

This is achieved by the libGLESv1_CM.so and libGLESv2.so libraries being implemented trampolines⁴, calling into function mapping tables provided by the vendor-provided hardware drivers. The tables contain slots for both GL ES 1.1 and 2.0 functions, with the shared symbol names having one common slot. A dummy slot to catch calls made without a current EGL context (an error per the specification) results in five instances of the mapping table⁵ overall. ⁴A thin function which only calls another function.⁵Selected by the hardcoded TLS variable slot TLS_SLOT_OPENGL_API.

gralloc

gralloc is Android's generic graphics allocator. gralloc as provided in Gingerbread has two modes: primarily targeted towards software renderers such as Skia, but also towards GL ES clients, which are able to allocate GPU-accessible memory. Using a unique handle for each buffer, gralloc allows buffers to be shared between processes, allowing full synchronisation between rendering occurring in different clients.

Whilst a rather capable and flexible solution, OpenMobile cannot use gralloc in any meaningful way, as it is often not implemented by the host OS.

Shared Memory Transport

Non-accelerated implementations of ACL (i.e., those that do not take advantage of host hardware acceleration) intercept the eglSwapBuffers routine—a request to present the current back buffer—in Android clients, used gralloc to map its underlying pixel storage into the process's memory space, and copied the result into the host X server by calling XPutImage.

XPutImage is an X11 request which takes the pixels provided by the caller (in this case, the mapped view of the back buffer), and copies them over a UNIX socket to the X server, inline with all X11 requests. The socket is optimised for small and frequent transfers; copying full buffer contents often causes expensive stalls of the client and server as they struggle to complete the copy with a fully blocked socket.

A way to mitigate this is to use the X11 MIT-SHM extension, available since 1989, which makes use of out-of-band shared memory segments to copy pixel data. While the data must often be copied anyway—particularly if it must be composited through OpenGL ES—using SHM can remove two copies, and also the expensive socket-full stalls.

Non-accelerated ACL implementations can be adapted to write directly into SHM rather than using XPutImage, eliminating two full-window copies from the path of every single update. This would not, however, provide hardware acceleration support.

Embodiments with Host Hardware Graphics Acceleration

Host OS Hardware Support

The host OS typically provides a GL ES implementation, as well as an EGL implementation targeting its (non-Android) native window system. These are written to render directly into host window system buffers: for Tizen these are the pixel storage provided by X11 Window and Pixmap objects. To support accelerated 3D rendering in Android applications, their GL rendering must be made directly target this storage.

Implementing accelerated 3D support benefits from changes in the Android class GraphicBuffer et al, replacement of the class FramebufferNativeWindow with one targeted for the X11 window system, and bypassing gralloc altogether. It also benefits from intercepting most of the EGL API called by Android clients to translate Android EGL types into host EGL types, and a careful combination of both Android and native calls to present the final rendered content through the screen.

EGL Wrapper in app_runner

Acting as the linker for Android applications running in the illustrated embodiments and other discussed herein, app_runner provides an opportunity to perform the translation between the Android EGL types provided by applications, and the host native types.

Android code calls eglGetDisplay with EGL_DEFAULT_DISPLAY. A real X11 Display is needed to pass to the host eglGetDisplay, and also for direct X11 calls inside modified Android classes and app_runner itself. For synchronisation purposes, these are preferably all be the same display, to avoid visual glitches and bugs arising from ordering issues. The embodiments discussed here rely on X11 code in GraphicBuffer or HostNativeWindow to open an X11 display, and pass this to eglGetDisplay. The X11 Display is cached, and all following calls will return the same EGLDisplay. As we do not reference-count the EGLDisplay, and we need the same display in several places, eglTerminate is overridden to do nothing.

All EGLConfig related functions—eglGetConfigs, eglChooseConfig, and eglGetConfigAttrib—are intercepted inside app_runner; Android requires a very specific set of configs, and for the EGL native visual ID to be a Android PixelFlinger format value. Therefore we cannot simply pass EGL configs from the X11-based host implementation through to Android applications. Whenever an EGL function that takes an Android config as an argument is called, the function is either completely implemented in app_runner using the shadow table of configs exposed to Android apps, or the host EGL function is called with the corresponding X11 config.

app_runner has a hard-coded list of Android EGL configs, for each of which we look up the corresponding X11 config. However, there are pre-defined Android EGL configs which we cannot support, as the host OS's implementation offers no equivalent or acceptable alternative.

Unusually, the Tizen X server does not offer any 16 bpp visuals⁶ (as can be verified with the xdpyinfo command); thus the Tizen EGL does not expose any 16 bpp configs for window surfaces (see Appendix: Tizen EGLConfigs), as without a matching visual, correct rendering is impossible. One of the pre-defined Android EGL configs is a 16 bpp window-capable config, which some Android applications have been written to rely on, and will not run otherwise. The solution is to lie: we expose a 16 bpp Android window config, which actually uses a 32 bpp window config on the host side. Applications cannot see the difference, as GL ES internally performs its rendering at 32 bpp without app intervention, and all pixel transfer operations where the contents are made visible to the application, require an argument indicating the pixel format on the application side. As the application specifies a 16 bpp pixel format, it always sees the results in 16 bpp, at the cost of the GPU performing the extra format conversion. The only visible result is the extra memory required for 32 bpp surfaces. ⁶This is rather unique, as X11 goes out of its way to unconditionally support both depths and bits per pixel values of 1, 2, 4, 8, 16, 24 and 32. The code to support this must have been explicitly removed for Tizen.

This allows for a trick: while we have no 16 bpp X11 window configs, we do have 16 bpp X11 pixmap configs, as X11 Pixmaps only require a numeric depth value, rather than a server-supported Visual. The host X server still retains support for colour depths other than 24 or 32. Therefore, when a 16 bpp pixmap-capable surface is requested, we are able to provide this backed by a real 16 bpp EGL config. The 8 bpp configs are also fabricated, but they are seemingly rarely-used, and we have yet to see issues caused by these.

The actual mapping of Android configs to X11 configs is created by FindBestX11Config in egl_my_table.c of app_runner. For each pre-defined Android config, a list of candidate X11 configs is fetched from the host's eglChooseConfig. This step guarantees that the list of candidates is compatible in EGL terms, e.g. they are renderable for the right surface types and have at least the requested number of bits in each color channel. A matching score is then computed for each candidate, judging its compatibility with the Android config. The X11 config with the best matching score is chosen, or if scoring fails, the first candidate is used.

The scoring algorithm primarily prefers X11 configs which have the exact same number of bits per pixel as the Android config, and secondarily prefers configs that do not have ancillary buffers wasting memory. More scoring rules would be required if the host EGL offered a larger variety of configs, e.g. GLES2-renderable configs without depth or stencil buffers. This custom scoring is required as the host's eglChooseConfig violates the EGL specification with regards to config ordering.

The app_runner wrapper for eglCreateWindowSurface has two modes of operation operation. If the attrib_list argument is APP_RUNNER_OVERRIDE_MAGIC, the call is passed directly to the host eglCreateWindowSurface, with the attrib_list removed. This mode is used by HostNativeWindow, to pass in an X11 Window created by the application.

Otherwise, when called by native Android applications, it is passed an ANativeWindow pointer as the EGLNativeWindowType. In that case, app_runner transparently creates a new X11 window is created off-screen, and the host eglCreateWindowSurface is called with the newly-created window. This X11 window is only created for its buffer storage, and is never displayed by the host OS. struct surface_mapping is used inside app_runner to track the association between the resulting EGLSurface, ANativeWindow, and the internal X11 window.

Native Android code should never be attempting to create a pixmap or pbuffer surface⁷; this functionality is unsupported by the EGL wrapper. While pbuffer may work without further development, support for Android EGL Pixmap surfaces was not pursued during development, as it was not originally supported, and this has not been shown to be problematic. Support for X11 Pixmap surfaces⁸ is present, but this is only used by internal ACL code. ⁷Through eglCreatePbufferSurface, eglCreatePbufferFromClientBuffer, or eglCreatePixmapSurface.⁸Selected by specifying APP_RUNNER_OVERRIDE_MAGIC as the attrib_list argument.

The eglSwapBuffers wrapper first always calls the host eglSwapBuffers directly, in order to flush any pending rendering. If there is no struct surface_mapping entry for the surface (i.e. it does not have an ANativeWindow), returns immediately after this. However, if there is a surface_mapping entry, it is dealing with a native Android application's SurfaceFlinger-based window, and we need to post the just-rendered buffer to SurfaceFlinger. This posting is done by calling ANativeWindow's queueBuffer method. This is immediately followed by calling the dequeueBuffer method; the host EGL implementation does not tell us when it requires a new buffer to render into, so we have to assume that we need a new buffer immediately⁹. If the Android window size has changed, we also resize the X11 window to match the new size. ⁹Further buffer usage details are explained in the section Android GL applications.

GLES Wrapper in app_runner

While EGL usage must be heavily translated between Android and host OS idioms, GLES remains almost entirely unmodified.

HostNativeWindow

SurfaceFlinger originally used a FramebufferNativeWindow¹⁰ class as its rendering target. FramebufferNativeWindow is an abstraction of a direct-to-screen rendering path without a real window system behind it. It can be described as rendering to the hardware framebuffer, except it usually involves handling several graphic buffers: at least a front and a back buffer, and sometimes more (a flip queue). ¹⁰libs/ui/FramebufferNativeWindow.cpp

FramebufferNativeWindow has been replaced with HostNativeWindow¹¹, whose name implies that it talks to the host OS instead of directly using the framebuffer. Here, it talks to the X11 window system, and allows the SurfaceFlinger output to appear on the Tizen screen as just another X11 window. As X11 provides also user input, relaying input from the host OS to the Android system is done in HostNativeWindow too, unlike FramebufferNativeWindow. ¹¹libs/ui/HostNativeWindow.cpp

In terms of graphics, the primary responsibility of HostNativeWindow is to connect to the X11 display and create a X11 Window for SurfaceFlinger will render to, as well as an EGL context for SurfaceFlinger's GL ES rendering.

Like all EGL calls originating from Android processes, calls from HostNativeWindow are intercepted by app_runner's EGL wrapper. However, as HostNativeWindow usually passes X11-specific EGL types rather than Android types, it must provide a hint to the wrapper that this is happening, to avoid double-translation. eglChooseConfig is passed a magic attribute¹² which causes the wrapper to return a config specially chosen for display inside an on-screen X11 window. ¹²The EGL_NATIVE_VISUAL_ID attribute is given the magic number 0xffff, which is not a valid PixelFlinger format code.

As a result, app_runner is responsible for selecting SurfaceFlinger output's pixel format. This is unfortunate, as the config selected inside app_runner must correspond to the Visual of the X11 Window created inside HostNativeWindow. While this is observably the case in the current Tizen implementation, a more co-ordinated approach where these values are selected in the same place would provide a stronger guarantee that these values will always be compatible.

Another significant exception is eglCreateWindowSurface, which in HostNativeWindow is called with an X11 Window rather than an ANativeWindow. We again use a magic attribute value¹³ to inform the wrapper in app_runner that it is indeed getting an X11 Window as the surface type, and does not need to create an off-screen Window. ¹³The attrib_list argument contains APP_RUNNER_OVERRIDE_MAGIC, which is not a valid EGL attribute, and therefore must be stripped out before calling the host OS function.

As HostNativeWindow is an implementation of ANativeWindow, it needs to provide the window methods:

setSwapInterval: Trivially calls eglSwapInterval.

dequeueBuffer: Returns a HostNativeBuffer referring to the X11 Window, but expects that it is not used for buffer management, as the host EGL API does not support explicit buffer management. The HostNativeBuffer just refers to the X11 Window, i.e. a surface type rather than an actual buffer. This method should only ever be called by the wrappers in app_runner for eglCreateWindowSurface and eglSwapBuffers.

lockBuffer: The current implementation appears to not be functional. It is never called in normal operation, as SurfaceFlinger does not access the buffer with the CPU.

queueBuffer: Simply calls eglSwapBuffers to post the SurfaceFlinger rendering onto screen. As with dequeueBuffer, not used for direct buffer management.

query and perform: Trivial implementations with no special X11-specific code.

cancelBuffer: Not implemented. app_runner's eglDestroySurface wrapper will not call this, as APP_RUNNER_OVERRIDE_MAGIC was used in the eglCreateWindowSurface call.

GraphicBuffer: The Android Buffer Class

GraphicBuffer is the C++ class representing a buffer containing pixels in Android, which originally called gralloc methods. It wraps (inherits from) android_native_buffer_t. The native buffer type contains a handle member of type buffer_handle_t¹⁴, which is ordinarily a gralloc buffer. However, as we are completely bypassing gralloc, we do not use the usual buffer_handle type. Our own buffer handle type is acl_buffer_handle_t. Pointers to acl_buffers (objects of type acl_buffer_handle_t) are simply cast to and from buffer_handle_t. ¹⁴Defined in android/system/core (not under frameworks/base); also known as native_handle.

GraphicBuffer is modified to work directly with acl_buffer_handle_t. A new class—GraphicBufferHelper—has been introduced as a common place to manage acl_buffers, and it largely replaces GraphicBufferAllocator which creates and destroys gralloc buffers. The GraphicBufferMapper class has rewritten to work on acl_buffers instead.

All graphic buffers in the new world of acl_buffer_handle_t are based on X11 Pixmaps. A Pixmap provides the backing storage for every acl_buffer; passing Pixmaps from one process to another is trivial, as the Pixmap ID is an integer usable by all X11 clients. Pixmaps were chosen as the host EGL/GL can render directly into them; even when a Window is used for more complex GL clients, we can still obtain a Pixmap referring to the Window's underlying storage¹⁵. ¹⁵The X11 Composite extension's XCompositeNameWindowPixmap call provides this mapping.

A new GraphicBuffer object can be initialized in one of two different ways:via the initSize method, which allocates a new X11 Pixmap to back an acl_buffer from within the client, or the unflatten method, which creates an acl_buffer referring to an existing Pixmap. The acl_buffer is then created by GraphicBufferHelper's init_acl_buffer method, which is passed the Pixmap to use. The first time a GraphicBuffer is initialised in a particular process, an X11 Display and EGLDisplay will be created, as described in the section EGL wrapper in app_runner.

init_acl_buffer also creates an EGLSurface from the Pixmap, and a new EGLContext for GL ES 1.1. These objects are required if the buffer contents are to be accessed by the CPU (Skia), as all pixel transfer to and from the Pixmap is performed through GL ES¹⁶. ¹⁶This transfer could be done directly through X11, however using GLES reduces the number of buffer copies required, as well as providing any necessary format conversion. Using X11 directly would require manual software-based format conversion for 16 bpp surfaces, which are commonly used under X11.

Support for the EGL_lock_surface_KHR extension, which allows for direct access to the surface's backing memory, has been provided, however the implementation in the Tizen host OS does not directly match the formats Android uses for software rendering, and is thus not usable.¹⁷ ¹⁷During development, it was noted that Skia and Android's low-level PixelFlinger library could be modified to use the formats supported by the lock_surface extension, however this option was not pursued due to lack of time.

The lockable flag in the acl_buffer is always false; therefore, calling GraphicBuffer's lock method to map a buffer for CPU access will always fall back to GraphicBufferHelper's map_and_copy and unmap_and_copy routines.

map_and_copy is called to create a new CPU-accessible mapping of the buffer contents, usually for software rendering through Skia. Memory is allocated to hold the CPU accessible copy (acl_buffer->cpu_copy). The code to actually do the copy from the Pixmap into cpu_copy is disabled, as it seems to be unnecessary. This is an important performance optimisation, as reading the surface contents back from GL ES into the CPU copy¹⁸ is a particularly expensive operation. ¹⁸Via glReadPixels

In practice, we have never observed a buffer first being rendered to with GL ES, and then read via map_and_copy; nor have we observed one process writing to a buffer, and another process then mapping it for CPU reading¹⁹. The CPU mapping, once allocated, will remain until the GraphicBuffer object is deallocated. ¹⁹20 The only inter-process buffer passing used in Gingerbread is passing a completed buffer to SurfaceFlinger for compositing via GL ES.

GraphicBufferHelper's unmap_and_copy is significantly more complex, as it has to upload the software-rendered content into the surface, through GL ES rendering calls. Firstly, it switches to the acl_buffer's unique EGL context, to avoid interfering with any active EGL context used by the application itself. It then uploads the pixels from cpu_copy into a GL ES texture via glTexImage2D, and blits (copies) the texture contents into the Pixmap with a GL ES rendering operation (glDrawArrays et al). An early experiment attempted to eliminate the GL rendering operation, however GL ES mandates the two-pass approach, where we first upload to a GL ES texture and then copy the GL texture to the surface. This potential performance issue has been mitigated by copying only the rectangle that was locked to begin with²⁰. Finally, the application EGL context is restored. ²⁰The lock function is given a rectangle specified by the application, of the area it will modify.

The GL ES coordinate system has its Y-axis flipped compared to normal operation²¹, which we have to compensate for. In our case, Pixmap content written in unmap_and_copy ends up upside-down in the buffer. We could flip the image in the rendering pass, but then if we ever needed to do the copy in map_and_copy, the reversed co-ordinate spaces in glReadPixels and glTex(Sub)Image2D would not conveniently cancel each other out. Hence, we set a local flag: acl_buffer->upside_down. This flag is used to modify the buffer transform attribute in Surface::queueBuffer²², when the buffer is being sent to SurfaceFlinger for display. SurfaceFlinger will then perform its GL ES blit in reverse, at no cost as the blit is being performed regardless of buffer orientation. ²¹The GL ES co-ordinate system is often referred to as graph paper, for its mathematical basis of having the origin in the bottom-left corner; most graphics APIs use the top-left corner as the origin.²²libs/surfaceflinger_client/Surface.cpp

SurfaceFlinger uses GraphicBuffer objects in the Layer and TextureManager classes by fetching its acl_buffer and creating an EGLImage from the Pixmap to use as the backing storage of a GL texture. The main functions are eglCreateImageKHR and glEGLImageTargetTexture2DOES, which are EGL/GLES extension functions²³. Every time the X11 Pixmap contents change, the EGLImage should be destroyed and created again. ²³24 These functions are provided by the EGL_KHR_image_base, EGL_KHR_image_pixmap, and GL_OES_EGL_image extensions. Otherwise the extension specification does not guarantee that the changes are visible in the GL texture.

Android GL Applications

The eglCreateWindowSurface implementation in app_runner must return an EGLSurface that the host GL can render to, as eglMakeCurrent calls are passed directly from Android applications through to the host EGL library. As explained in the section EGL wrapper in app_runner, a new X11 Window is created as the rendering target, and used in the host eglCreateWindowSurface. This produces the EGLSurface which is then returned to the Android application. Using a Window instead of Pixmap offers implicit double-buffering, so we do not have to create multiple Pixmaps and switch between them.

However, we do not know when the surface is created, that we will be using GL ES to render rather than software rendering. As discussed earlier, using Pixmaps rather than Windows is desirable for a number of reasons, however GL ES rendering strictly requires actual X11 Windows rather than Pixmaps.

This poses a slight problem, as on Android the SurfaceFlinger service is the one allocating all buffers, and thus allocates an X11 Pixmap for our surface, not knowing that we will be creating our own Window. Android does not support changing the backing storage of a GraphicBuffer object in any way, so SharedBufferStack was modified to send a Pixmap ID along with the buffer index and attributes, so we can insert the ID of the Pixmap providing storage for our client-created Window, rather than reusing the SurfaceFlinger-created Pixmap.

This occurs in the queueBuffer function, where we pass the buffer to SurfaceFlinger for rendering. Inside SurfaceFlinger, the new Pixmap ID is retrieved in Layer's lockPageFlip function, which renders a surface, and passed to reloadTexture, which passes it to Layen:BufferManager's initEglImage; eventually TextureManager's initEglImage writes it into acl_buffer->x11_pixmap, while also using it to create the EGLImage for SurfaceFlinger's use.

A more complete understanding of the operation of systems according to the invention may be attained by reference to U.S. patent application Ser. No. 14/061,288 (now, U.S. Patent Publication No. US 2014-0115606), filed Oct. 23, 2013, and U.S. Patent Application Ser. No. 61/892,896, filed Oct. 18, 2013, both entitled MULTI-PLATFORM MOBILE AND OTHER COMPUTING DEVICES AND METHODS,” the teachings of which are incorporated by reference herein.

### CONCLUSION

Described above and shown in the drawings are devices and methods meeting the desired objects, among others. Those skilled the art will appreciate that the embodiments described and shown here in our merely examples of the invention and that other embodiments, incorporating changes to those here, fall within the scope of the invention, as well.

In view thereof, what we claim is:

1. A computing device comprising:
A. a graphics processing unit,
B. a display that is coupled for communications with the graphics processing unit,
C. a central processing unit that is coupled for communications with that graphics processing unit and the display, the central processing unit executing a native operating system including one or more native runtime environments within which native software applications are executing, where each such native software application has instructions for execution under the native operating system,
D. a first native software application (“ACL”) executing within one or more of the native runtime environments defines one or more hosted runtime environments within which hosted software applications are executing, where each such hosted software application has instructions for execution under a hosted operating system that differs from the native operating system,
E. at least one hosted software application executing within the hosted runtime environment(s) execute instructions to effect generation of any of two- and three-dimensional display graphics using a hosted graphics subsystem and a hosted windowing subsystem (collectively, “hosted graphics framework”), both common to the hosted runtime environment(s),
F. native software applications executing within the native runtime environment(s) execute instructions to effect generation of any of two- and three-dimensional display graphics using a native graphics subsystem and a native windowing subsystem (collectively, “native graphics framework”), both common to the native runtime environment(s),
G. the native graphics framework is coupled to the graphics processing unit to accelerate execution of at least certain instructions in the native software applications, and
H. the hosted graphics framework and the native graphics framework cooperate to accelerate execution of at least certain instructions in the hosted software applications using the graphics processing unit.

2. The computing device of claim 1 in which
A. at least one hosted software application executing within the hosted runtime environment(s) execute instructions to effect generation of three-dimensional display graphics using a hosted graphics subsystem and a hosted windowing subsystem (collectively, “hosted graphics framework”), both common to the hosted runtime environment(s),
B. native software applications executing within the native runtime environment(s) execute instructions to effect generation of three-dimensional display graphics using a native graphics subsystem and a native windowing subsystem (collectively, “native graphics framework”), both common to the native runtime environment(s),

3. The computing device of claim 1 in which
A. at least one hosted software application executing within the hosted runtime environment(s) execute instructions to effect generation of two-dimensional display graphics using a hosted graphics subsystem and a hosted windowing subsystem (collectively, “hosted graphics framework”), both common to the hosted runtime environment(s),
B. native software applications executing within the native runtime environment(s) execute instructions to effect generation of two-dimensional display graphics using a native graphics subsystem and a native windowing subsystem (collectively, “native graphics framework”), both common to the native runtime environment(s),

4. The computing device of claim 1 in which the native graphics framework includes (i) a native graphics interface component (“EGL”) that effects allocation of off-screen buffers, and (ii) a native compositor that generates a composite graphic from such buffers and transmits that graphic for presentation on the screen.

5. The computing device of claim 4 in which the native graphics framework responds to instructions executed by the native software applications by populating respective ones of those off-screen buffers with graphics.

6. The computing device of claim 5 in which the native graphics interface component creates an off-screen buffer and passes at least an identifier of that buffer to the hosted graphics framework to be populated with graphics by it in response to instructions executed by the hosted software applications.

7. The computing device of claim 4 in which the hosted graphics framework includes a hosted compositor that generates a composite graphic from one or more off-screen buffers passed to the hosted graphics framework and assigned by the native graphics interface component to one or more hosted software applications.

8. The computing device of claim 7 in which the computing device includes a frame buffer that is coupled to the display and drives graphics thereto for presentation thereon.

9. The computing device of claim 8 in which the hosted graphics framework and the native graphics framework cooperate to transfer the composite graphic to at least one of the graphics processing unit and the computing device's display.

10. The computing device of claim 9 in which the native graphics interface component creates an off-screen buffer and passes at least an identifier of that buffer to the hosted graphics framework to be populated with the composite graphic by the hosted compositor.

11. The computing device of claim 4 in which the off-screen buffer passed by the native graphics interface component to the hosted graphics framework is a pixmap.

12. The computing device of claim 1 in which the at least one hosted software application comprises a hybrid application executing on the CPU in a single application address space established within said native operating system.

13. The computing device of claim 12, wherein the hybrid application includes (i) instructions comprising a hosted software application built and intended for execution under a hosted operating system that differs from the native operating system, and (ii) instructions from at least one of a runtime library and another resource of the native runtime environment.
